(19) United States
(12) Patent Application Publication
(10) Pub. No.: US 2024/0406984 A1
(43) Pub. Date: Dec. 5, 2024

(54) Method for Handling Side Link (SL) Communication Over an Unlicensed Spectrum

(71) Applicant: Telefonaktiebolaget LM Ericsson (publ), Stockholm (SE)

(72) Inventors: Majid Gerami, Lund (SE); Bikramjit Singh, Raasepori (FI); Min Wang, Luleå (SE)

(21) Appl. No.: 18/699,459

(22) PCT Filed: Oct. 10, 2022
(86) PCT No.: PCT/SE2022/050912

§ 371 Date: Apr. 8, 2024

Related U.S. Application Data
(60) Provisional application No. 63/262,499, filed on Oct. 14, 2021.

(51) Int. Cl. H04W 72/40; H04W 92/18

(52) U.S. Cl. CPC H04W 72/40; H04W 92/18

(57) ABSTRACT

A method performed by a network node is provided. The method is for handling a Side Link (SL) communication over an unlicensed spectrum between one or more peers. The one or more peers comprises at least a first User Equipment (UE) and a second UE in a wireless communications network. The network node initiates (502) a Channel Occupancy Time (COT) to be used for the SL communication. The COT is a time period for performing SL communication using the unlicensed spectrum. The network node signals (503) an indication of COT parameters to at least one of the one or more peers, enabling at least one of the one or more of the peers, to start the SL communication during the COT.

### TECHNICAL FIELD

Embodiments herein relate to a network node, and methods therein. Embodiments herein further relate to a first User Equipment (UE) or a second UE, and methods therein. In some aspects, they relate to handling a Side Link (SL) communication over an unlicensed spectrum between one or more peers. The one or more peers comprises at least a first User Equipment, UE, and a second UE in a wireless communications network.

Embodiments herein further relates to computer programs and carriers corresponding to the above methods, wireless terminal, and network node.

### BACKGROUND

In a typical wireless communication network, wireless devices, also known as wireless communication devices, mobile stations, stations (STA) and/or User Equipments (UE) s, communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a Radio Base Station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHZ frequency bands. Some of these bands are bands traditionally used by legacy standards but have been extended to cover potential new spectrum offerings from 410 MHz to 7125 MHz FR2 comprises frequency bands from 24.25 GHz to 52.6 GHZ. Bands in this millimetre wave range have shorter range but higher available bandwidth than bands in the FR1.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

### 2.1.1 NR-U Introduction

In order to tackle with the ever increasing data demanding, NR is supported on both licensed and unlicensed spectrum, i.e., referred to as NR Unlicensed spectrum (NR-U). Compared to the LTE Licensed-Assisted Access (LAA), NR-U supports Dual Connectivity (DC) and standalone scenarios, where the Medium Access Control (MAC) procedures including Random Access Channel (RACH) and scheduling procedure on unlicensed spectrum are subject to Listen Before Talk (LBT) failures, while there was no such restriction in LTE LAA, since there was licensed spectrum in LAA scenario so the RACH and scheduling related signalling can be transmitted on the licensed spectrum instead of unlicensed spectrum.

Access to a channel in the unlicensed spectrum, especially in the 5 GHZ and 6 GHz band, is guaranteed by LBT requirements defined by regulations, unlike licensed spectrum which is assigned to a specific operator. The LBT mechanism mandates a device to sense for the presence of other users' transmissions in the channel before attempting to transmit. The device performs Clear Channel Assessment (CCA) checks on the channel using Energy Detection (ED) before transmitting. If the channel is found to be idle, i.e. energy detected is below a certain threshold, the device is allowed to transmit. Otherwise, if the channel is found to be occupied, the device must defer from transmitting. This mechanism reduces interferences and collisions to other systems and increases probabilities of successful transmissions when the energy in a CCA slot is sensed to be below the ED threshold. Regulatory requirements in some regions specify the maximum allowed ED threshold, thus setting a limit on the most aggressive behaviour transmitters may have.

As described in 3GPP TR 38.889, the channel access schemes for NR-based access for unlicensed spectrum can be classified into the following categories (Cat; CAT):
Category 1: Immediate transmission after a short switching gap, i.e., also referred to as no LBT operation.
   This is used for a transmitter to immediately transmit after a Uplink (UL)/Downlink (DL) switching gap inside a COT.
   The switching gap from reception to transmission is to accommodate the transceiver turnaround time and is no longer than 16 μs.
Category 2: LBT without random back-off, also referred to as one shot LBT.
   The duration of time that the channel is sensed to be idle before the transmitting entity transmits is deterministic.
Category 3: LBT with random back-off with a contention window of fixed size.
   The LBT procedure has the following procedure as one of its components. The transmitting entity draws a random number N within a contention window. The size of the contention window is specified by the minimum and maximum value of N. The size of the contention window is fixed. The random number N is used in the LBT procedure to determine the duration of time that the channel is sensed to be idle before the transmitting entity transmits on the channel.
Category 4: LBT with random back-off with a contention window of variable size.
   The LBT procedure has the following as one of its components. The transmitting entity draws a random number N within a contention window. The size of contention window is specified by the minimum and maximum value of N. The transmitting entity can vary the size of the contention window when drawing the random number N. The random number N is used in the LBT procedure to determine the duration of time that the channel is sensed to be idle before the transmitting entity transmits on the channel.
For different transmissions in a COT and different channels/signals to be transmitted, different categories of channel access schemes can be used.
NR-U supports two different LBT modes, dynamic and semi-static channel occupancy for two types of equipment; Load based Equipment (LBE) and Frame based equipment (FBE), respectively.

### COT Sharing in NR Unlicensed Spectrum

For a node (e.g., NR-U gNB/UE, LTE-LAA eNB/UE, or Wi-Fi AP/STA)) to be allowed to transmit in unlicensed spectrum (e.g., 5 GHz band) it typically needs to perform a Clear Channel Assessment (CCA). This procedure typically includes sensing the medium to be idle for a number of time intervals. Sensing the medium to be idle can be done in different ways, e.g., using ED, preamble detection or using virtual carrier sensing. The latter implies that the node reads control information from other transmitting nodes informing when a transmission ends. After sensing the medium to be idle, the node is typically allowed to transmit for a certain amount of time, sometimes referred to as transmission opportunity (TXOP). The length of the TXOP depends on regulation and type of CCA that has been performed, but typically ranges from 1 ms to 10 ms. This duration is often referred to as a COT (Channel Occupancy Time).

In Wi-Fi, feedback of data reception acknowledgements (ACKs) is transmitted without performing clear channel assessment. Preceding feedback transmission, a small time duration (called SIFS) is introduced between the data transmission and the corresponding feedback which does not include actual sensing of the channel. In 802.11, the SIFS period (16 μs for 5 GHZ OFDM PHYs) is defined as:

$$aSIFSTime = aRxPHYDelay + aMACProcessingDelay + aRxTxTurnaroundTime .$$

### Wherein:

aRxPHYDelay defines the duration needed by the PHY layer to deliver a packet to the MAC layer.
aMACProcessingDelay defines the duration that the MAC layer needs to trigger the PHY layer transmitting a response.
aRxTxTurnaroundTime defines the duration needed to turn the radio from reception into transmit mode.
   Therefore, the SIFS duration is used to accommodate for the hardware delay to switch the direction from reception to transmission.

It is anticipated that for NR in unlicensed bands (NR-U), a similar gap to accommodate for the radio turnaround time will be allowed. For example, this will enable the transmission of Physical Uplink Control Channel (PUCCH) carrying Uplink Control Information (UCI) feedback as well as Physical Uplink Shared Channel (PUSCH) carrying data and possible UCI within the same transmit opportunity (TXOP) acquired by the initiating gNB without the UE performing clear channel assessment before PUSCH/PUCCH transmission as long as the gap between DL and UL transmission is less than or equal to 16 us. Operation in this manner is typically called “COT sharing.” An example on COT sharing is illustrated in FIG. 1. FIG. 1 illustrates Transmission opportunities (TXOP) both with and without COT sharing where CCA is performed by the initiating node (gNB). For the case of COT sharing the gap between DL and UL transmission is less than 16 us.

When UE accesses medium via Cat-4 LBT with a configured grant outside of a gNB COT, it is also possible for UE and gNB to share the UE acquired COT to schedule DL data to the same UE. UE COT information can be indicated in UCI such as Configured Grant (CG) UCI for configured grant PUSCH resources. An example of a UE initiated COT is illustrated in FIG. 2. FIG. 2 illustrates an example on a UE COT sharing with the DL transmission. For the case of COT sharing the gap between UL and DL transmission is less than 16 us.

### Dynamic Channel Occupancy by Load Based LBE

3GPP Release 16 Work Item (WI) NR-U specifies a dynamic channel access mechanism for an LBE type device. The procedure is designed to randomize the start of transmissions from different nodes that want to access the channel at the same time. This procedure is commonly known as Category 4 (CAT4) LBT, the detailed procedure for category 4 LBT (also named as Type 1 channel access in TS 37.213 V 16.1.0) is described as below.

A UE may transmit the transmission using Type 1 channel access procedure after first sensing the channel to be idle during the slot durations of a defer duration, and after the counter N is zero in step 4. The counter N is adjusted by sensing the channel for additional slot duration(s) according to the steps described below.
1) set N=x where x is a random number uniformly distributed between 0 and C, and go to step 4;
2) if N>0 and the UE chooses to decrement the counter, set N=N−1;
3) sense the channel for an additional slot duration, and if the additional slot duration is idle, go to step 4; else, go to step 5;
4) if N=0, stop; else, go to step 2.
5) sense the channel until either a busy slot is detected within an additional defer duration or all the slots of the additional defer duration are detected to be idle;
6) if the channel is sensed to be idle during all the slot durations of the additional defer duration, go to step 4; else, go to step 5.

If a UE has not transmitted a UL transmission on a channel on which UL transmission(s) are performed after step 4 in the procedure above, the UE may transmit a transmission on the channel, if the channel is sensed to be idle at least in a sensing slot duration when the UE is ready to transmit the transmission and if the channel has been sensed to be idle during all the slot durations of a defer duration immediately before the transmission. If the channel has not been sensed to be idle in a sensing slot duration when the UE first senses the channel after it is ready to transmit, or if the channel has not been sensed to be idle during any of the sensing slot durations of a defer duration immediately before the intended transmission, the UE proceeds to step 1 after sensing the channel to be idle during the slot durations of a defer duration.

The defer duration consists of duration=16 us immediately followed by consecutive slot durations where each slot duration is =9 us, and includes an idle slot duration at start of;
CW_{min,p}≤CWₚ≤CW_{max,p} is the contention window. C adjustment is described in clause 4.2.2 of 3GPP TS 37.213.
CW_{min,p} and CW_{max,p} are chosen before step 1 of the procedure above.
   mₚ, CW_{min,p}, and CW_{max,p} are based on a channel access priority class p as shown in Table 1/Table 4.2.1-1 in TS 37.214 [3].

TABLE 1/TABLE 4.2.1-1
Channel Access Priority Class (CAPC) for
UL in TS 37.214 is illustrated below.

| Channel | | | | | |
|---|---|---|---|---|---|
| Access | | | | | allowed |
| Priority | | | | | CW [symbol] |
| Class (p) | m [symbol] | CW [symbol] | CW [symbol] | T [symbol] | sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 ms | {15, 31, 63, 127, 255, |
| | | | | | 511, 1023} |
| 4 | 7 | 15 | 1023 | 6 ms or 10 ms | {15, 31, 63, 127, 255, |
| | | | | | 511, 1023} |

NOTE1:
For p = 3.4, T [symbol] = 10 ms if the higher layer parameter absenceOfAnyOtherTechnology-r14 or absenceOfAnyOtherTechnology-r16 is provided, otherwise, T [symbol] = 6 ms.
NOTE 2:
When [symbol] = 6 ms it may be increased to 8 ms by inserting one or more gaps. The minimum duration of a gap shall be 100 us. The maximum duration before including any such gap shall be 6 ms. [symbol]
indicates data missing or illegible when filed

### Semi-Static Channel Occupancy by FBE

The Semi-static channel occupancy allows a Frame based equipment (FBE) to perform a clear channel assessment per fixed frame period for a duration of single 9 us observation slot. If the channel is found to be busy after CCA operation, the equipment shall not transmit during this fixed frame period. The fixed frame period can be set to a value between 1 and 10 ms and can be adjusted once every 200 ms. If the channel is found to be idle, the equipment can transmit immediately up to a duration referred to as channel occupancy time, after which the equipment shall remain silent for at least 5% of said channel occupancy time. At the end of the required idle period, the equipment can resume CCA for channel access. An example of the FBE based channel occupancy operation is shown in FIG. 3. FIG. 3 illustrates a semi-static channel occupancy operation.

The Semi-static channel occupancy generally has difficulty competing with devices that use dynamic channel occupancy, such as LAA or NR-U, for channel access. Dynamic channel occupancy device has the flexibility to access the channel at any time after a successful LBT procedure, while the semi-static channel occupancy devices have one chance for grabbing the channel every fixed frame period. The problems become more exacerbated with longer fixed frame period and higher traffic load. Secondly, the frame based LBT can be rather inflexible for coordinating channel access between networks. If all the nodes are synchronized, then all nodes will find the channel available and transmit simultaneously and cause interference. If the nodes are not synchronized, then some nodes may have definitive advantages in getting access to the channel over some other nodes. Nonetheless, semi-static channel occupancy can be good choice for controlled environments, where a network owner can guarantee absence of dynamic channel occupancy devices and is in control of the behaviour of all devices competing to access the channel. In fact, in such deployment, semi-static channel occupancy is an attractive solution because access latencies can be reduced to the minimum and lower complexity is required for channel access due to lack of necessity to perform random backoff.

It has been identified that FBE operation for the scenario where it is guaranteed that LBE nodes are absent on a long-term basis (e.g., by level of regulation) and FBE gNBs are synchronized can achieve the following:
Ability to use frequency reuse factor 1;
Lower complexity for channel access due to lack of necessity to perform random backoff.

In order to deploy a single operator FBE system, the gNBs need to be time aligned. All gNBs will perform the one-shot 9 us LBT at the same time. If the gNB indicates FBE operation, for an indication of LBT type of Cat2 25 us or Cat4 the UE follows the mechanism whereby one 9 microsecond slot is measured within a 25-microsecond interval.

The Fixed Frame Period (FFP) is restricted to values of {1 ms, 2 ms, 2.5 ms, 4 ms, 5 ms, 10 ms}, e.g., including the idle period. The starting positions of the FFPs within every two radio frames starts from an even radio frame and are given by i*P where i={0,1, . . . , 20/P-1} where P is the fixed frame period in ms.

The idle period for a given SCS=ceil (Minimum idle period allowed by regulations/Ts) where minimum idle period allowed=max (5% of FFP, 100 us), and Ts is the symbol duration for the given SCS.

For FBE, channel sensing is performed at fixed time instants. If the channel is determined busy, the base station adopts a fixed back-off and perform LBT again after the fixed backoff. For LBE, channel sensing can be performed at any time instance, and random back-off is adopted when the channel is determined to be busy.

As described in 3GPP TR 38.889, it has been identified that FBE operation for the scenario where it is guaranteed that LBE nodes are absent on a long term basis (e.g., by level of regulation) and FBE gNBs are synchronized can achieve the following: Ability to use frequency reuse factor 1; Lower complexity for channel access due to lack of necessity to perform random backoff. It is noted that this does not imply that LBE does not have benefits in similar scenarios although there are differences between the two modes of operation. It is also noted that FBE may also have some disadvantages compared to other modes of operation such as LBE, e.g., a fixed overhead for idle time during a frame. In NR Rel-16, it is only gNB COT sharing is supported in case of semi-static channel access by FBE. A UE may transmit UL transmission burst(s) after DL transmission within a gNB initiated COT. UE transmissions within a fixed frame period can occur if DL transmission for the serving gNB within the fixed frame period are detected. The detection of any DL transmission confirms that the gNB has initiated the COT. For this to work, the UE should be aware of the start and end of every FFP cycle. Such UE behaviours are not optimum for Ultra-Reliable Low Latency Communications (URLLC) like services which require critical latency requirements. UE initiated COT by FBE would be a complementary solution for URLLC.

### SL Transmission in NR

SL transmissions over NR are specified for Rel. 16. These are enhancements of the PROximity-based SErvices (ProSe) specified for LTE. Four new enhancements are particularly introduced to NR SL transmissions as follows:
Support for unicast and groupcast transmissions are added in NR SL. For unicast and groupcast, the Physical SL Feedback Channel (PSFCH) is introduced for a receiver UE to reply to the decoding status to a transmitter UE.
Grant-free transmissions, which are adopted in NR uplink transmissions, are also provided in NR SL transmissions, to improve the latency performance.
To alleviate resource collisions among different SL transmissions launched by different UEs, it enhances channel sensing and resource selection procedures, which also lead to a new design of Physical Sidelink Control Channel (PSCCH).
To achieve a high connection density, congestion control and thus the QoS management is supported in NR SL transmissions.
   Similar as for PROSE in LTE, NR SL transmissions have the following two modes of resource allocations:
Mode 1: Sidelink resources are scheduled by a gNB.
Mode 2: The UE autonomously selects SL resources from a (pre-) configured. SL resource pool(s) based on the channel sensing mechanism.

### SUMMARY

An object of embodiments herein is e.g., to improve the flexibility and/or performance of SL communication in wireless communications networks.

According to an aspect, the object is achieved by a method performed by a network node. The method is for handling a Side Link, SL, communication over an unlicensed spectrum between one or more peers. The one or more peers comprises at least a first User Equipment, UE, and a second UE in a wireless communications network. The network node initiates a Channel Occupancy Time, COT, to be used for the SL communication. The COT is a time period for performing SL communication using the unlicensed spectrum. The network node signals an indication of COT parameters to at least one of the one or more peers, enabling at least one of the one or more of the peers, to start the SL communication during the COT.

According to another aspect, the object is achieved by a method performed by a first User Equipment, UE, or second UE. The method is for handling a Side Link, SL, communication over an unlicensed spectrum between one or more peers. The one or more peers comprises at least the first UE and the second UE in a wireless communications network. The first UE, or the second UE receives an indication of Channel Occupancy Time, COT, parameters, wherein the COT is a time period for performing SL communication using the unlicensed spectrum. The first UE, or the second UE starts the SL communication during the COT based on access information indicated by the indication of COT parameters.

According to another aspect, the object is achieved by a network node. The network node is configured to handle a Side Link, SL, communication over an unlicensed spectrum between one or more peers. The one or more peers are adapted to comprise at least a first User Equipment, UE, and a second UE, in a wireless communications network. The network node is further configured to:
Initiate a Channel Occupancy Time, COT, to be used for the SL communication, wherein the COT is adapted to be a time period for performing SL communication using the unlicensed spectrum, and
signal an indication of COT parameters to at least one of the one or more peers, enabling at least one of the one or more of the peers to start the SL communication during the COT.

According to another aspect, the object is achieved by a UE, comprising a first User Equipment, UE, or a second UE. The UE is configured to handle a Side Link, SL, communication over an unlicensed spectrum, between one or more peers. The one or more peers comprises at least the first UE and the second UE in a wireless communications network. The UE comprising the first UE or the second UE being, is configured to:
Receive, an indication of Channel Occupancy Time, COT, parameters, wherein the COT is adapted to be a time period for performing SL communication using the unlicensed spectrum, and
Start the SL communication during the COT based on access information indicated by the indication of COT parameters.

An advantage of embodiments herein is providing an improved SL performance and/or flexibility by enabling signalling for SL transmission when a network node initiates COT. This is e.g., since:
The UE saves energy in sensing since the network node such as the gNB performs sensing and then shares the COT with the UE.
The network node such as the gNB may control SL transmission in unlicensed band by sharing a COT to a UE or not sharing and then controlling interference.
The latency is reduced since the UE starts transmission after COT initiated by the network node such as the gNB.

### BRIEF DESCRIPTION OF THE DRAWINGS

FIG. 1 is a schematic block diagram depicting prior art.

FIG. 2 is a schematic block diagram depicting prior art.

FIG. 3 is a schematic block diagram depicting prior art.

FIG. 4 is a schematic block diagram depicting embodiments of a wireless communications network.

FIG. 5 is a flow chart depicting embodiments of a method in a network node.

FIG. 6 is a flow chart depicting embodiments of a method in a UE.

FIG. 7 is a sequence diagram depicting embodiments of a method.

FIG. 8 is a sequence diagram depicting embodiments of a method.

FIG. 9 is a sequence diagram depicting embodiments of a method.

FIGS. 10 a and b are schematic block diagrams depicting embodiments of a network node.

FIGS. 11a and b are schematic block diagrams depicting embodiments of a UE.

FIG. 12 schematically illustrates a telecommunication network connected via an intermediate network to a host computer.

FIG. 13 is a generalized block diagram of a host computer communicating via a base station with a user equipment over a partially wireless connection.

FIGS. 14 to 17 are flowcharts illustrating methods implemented in a communication system including a host computer, a base station and a user equipment.

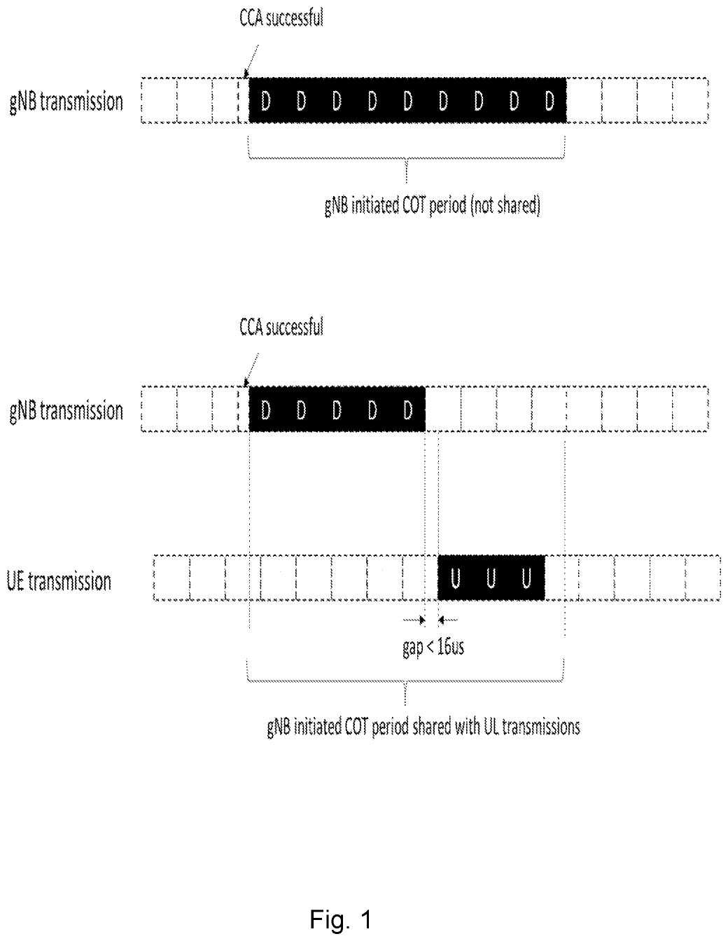

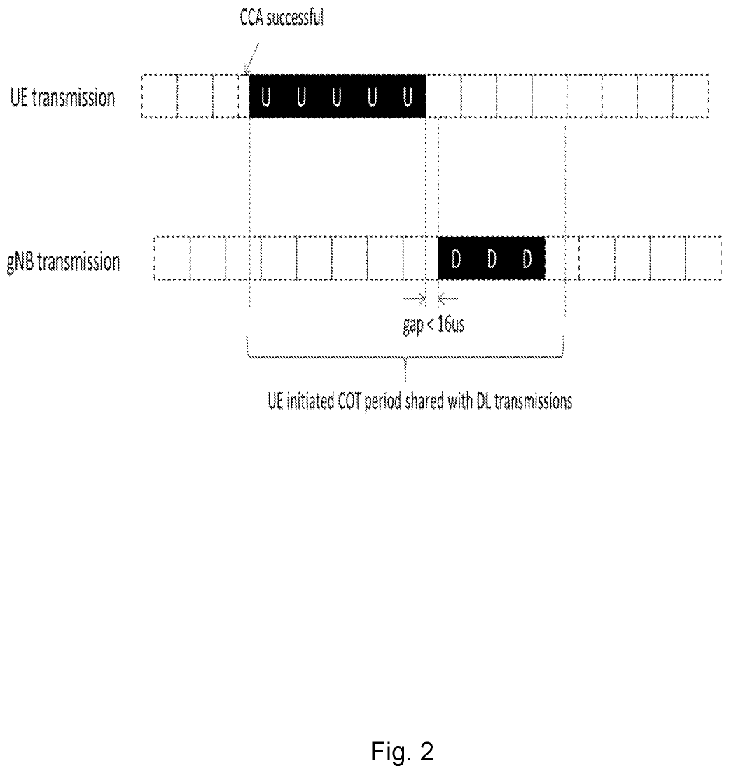

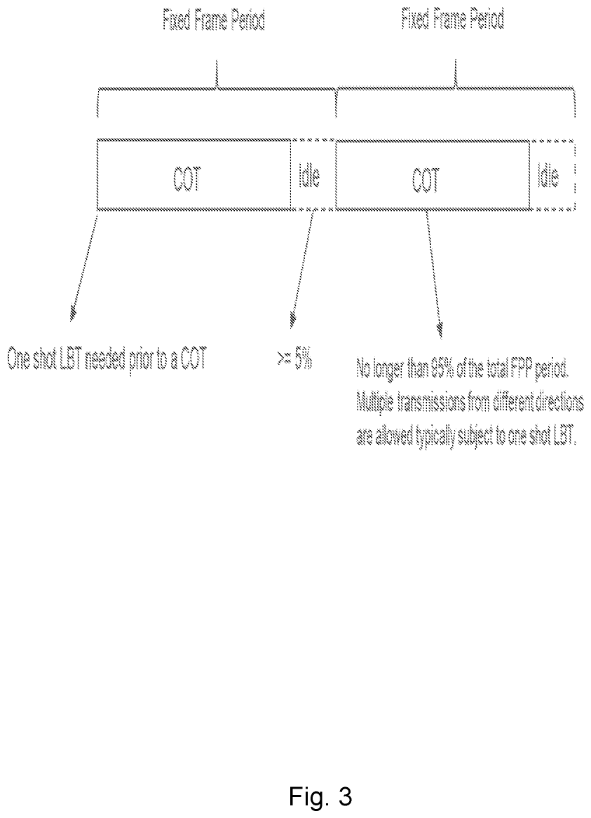

### DETAILED DESCRIPTION

As a part of developing embodiments herein the inventors identified a problem which first will be discussed.

To perform communication more efficiently between UEs in wireless communications network, SL transmissions are needed. Since the licensed spectrum may be used for other communication or may not satisfy the properties needed for the desired communication, it is desirable to perform SL communication on an unlicensed spectrum (SL-U). An unlicensed spectrum as used herein can be in any unlicensed band, e.g., 2.5, 5, 6 GHZ, FR1, FR2, 52.6 GHz-71 GHz, beyond 100 GHZ, and/or any suitable shared spectrum.

To support SL transmission on the SL-U, channel access mechanism, e.g., as in NR-U need to be introduced for SL-U. With a channel access mechanism, an SL-capable UE may need to perform LBT operation before an SL transmission. However, LBT operation will induce a large transmission latency for the SL transmission. In these cases, the COT sharing mechanism similar to NR-U would be beneficial to be also supported for SL-U.

However, the existing COT sharing mechanism in NR-U cannot be directly reused for SL-U. This is since, in NR-U, COT sharing enables a UE to share a UL COT with the gNB, i.e., so called UL COT sharing, or enables the gNB to share a DL COT with one or multiple UEs, i.e., so called DL COT sharing. In this way, unnecessary resources are reserved for the gNB, and no resources are reserved for communication between different UEs.

Hence, a problem arises in how to share an SL communication between UEs in an unlicensed spectrum.

An object of embodiments herein is e.g., to improve the flexibility and/or performance of SL communication in wireless communications networks.

Examples of embodiments herein provide an SL-U COT, e.g., for a network node such as a gNB to initiate a COT for SL transmission on an unlicensed spectrum and to share the COT with UEs needing to perform the SL transmission on the unlicensed spectrum. In this way, the performance and flexibility of communication is improved. This is since the UEs may now be able to communicate over the unlicensed spectrum e.g., in a manner indicated by the network node, during the initiated COT. The UEs herein may therefore attain a high-performance and/or flexible channel for communication during the COT, e.g., without having to synchronize the SL transmission data with the network node and may instead communicate directly with other UEs.

Some advantages of embodiments herein e.g., comprise:
Improving SL performance and/or flexibility by enabling signalling for SL transmission when a network node e.g., a gNB, initiates and shares an SL-U COT or e.g., shares a COT, e.g., a DL COT, UL COT, e.g., to be used as an SL COT. by providing details for how to perform the signalling.
Latency reduction: When a network node such as a gNB shares a COT, e.g., a UL/DL COT, for SL transmission e.g., to be used as an SL COT, the SL UE does not need to perform LBT process before SL transmission e.g., as will be explained and/or understood by the examples and embodiments herein. Skipping LBT may reduce the latency in transmitting SL data since data may be transmitted immediately without a long delay.
UE energy saving: Skipping LBT process may benefit the UE in saving energy as well, e.g., as will be explained and/or understood by the examples and embodiments herein. This is since in some embodiments herein UEs do not need to spend energy in listening repeatedly to the channel for when they may communicate. Instead e.g., in some embodiments they may be idle, e.g., and save energy/power, until they have the opportunity to perform SL communication.

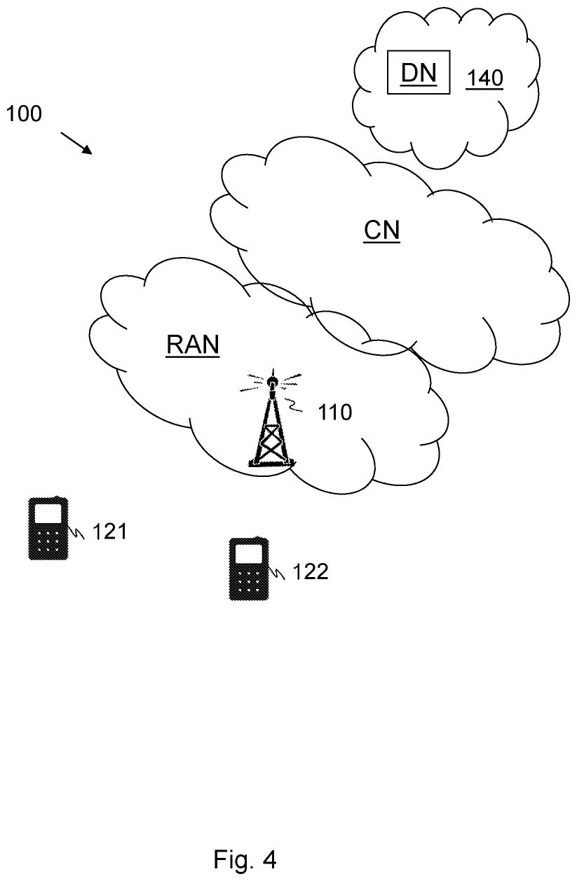

FIG. 4 is a schematic overview depicting a wireless communications network 100 wherein embodiments herein may be implemented. The wireless communications network 100 comprises one or more RANs and one or more CNs. The wireless communications network 100 may use 5G NR but may further use a number of other different technologies, such as, Wi-Fi, LTE, LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Network nodes such as a network node 110 operate in the wireless communications network 100. The network node 110 may e.g., provide a number of cells and may use these cells for communicating with e.g., a first UE 121 and/or a second UE 122. The network node 110 may be a transmission and reception point e.g., a radio access network node such as a base station, e.g., a radio base station such as a NodeB, an evolved Node B (eNB, eNodeB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a wireless terminal served by the network node 110, depending e.g., on the radio access technology and terminology used.

UEs operate in the wireless communications network 100, such as a first UE 121 and a second UE 122. The first UE 121 and/or the second UE 122 may be configured to communicate with each other over an unlicensed spectrum SL.

The first UE 121 and/or the second UE 122 may e.g., each respectively be an NR device, a mobile station, a wireless terminal, an NB-IoT device, an eMTC device, an NR RedCap device, a CAT-M device, a Wi-Fi device, an LTE device and a non-access point (non-AP) STA, a STA, that communicates via a base station such as e.g., the network node 110, one or more Access Networks (AN), e.g., RAN, to one or more core networks (CN). It should be understood by the skilled in the art that the term wireless terminal as used herein relates to a non-limiting term which means any UE, terminal, wireless communication terminal, wireless terminal, user equipment, Device to Device (D2D) terminal, or node e.g., smart phone, laptop, mobile phone, sensor, relay, mobile tablets or even a small base station communicating within a cell.

Methods herein may in some aspects be performed by the network node 110, and the first UE 121 and/or the second UE 122. As an alternative, a Distributed Node (DN) and functionality, e.g., comprised in a cloud 140 as shown in FIG. 4, may be used for performing or partly performing the methods.

Embodiments herein provides methods and signalling for the network node 110 initiating and/or sharing a COT for SL transmission, e.g., in an unlicensed spectrum, e.g., SL-U transmission.

In embodiments herein, when suitable, any suitable characteristics, configurations and/or parameters for other COTs, e.g., in NR-U COT for DL/UL, may apply to embodiments herein.

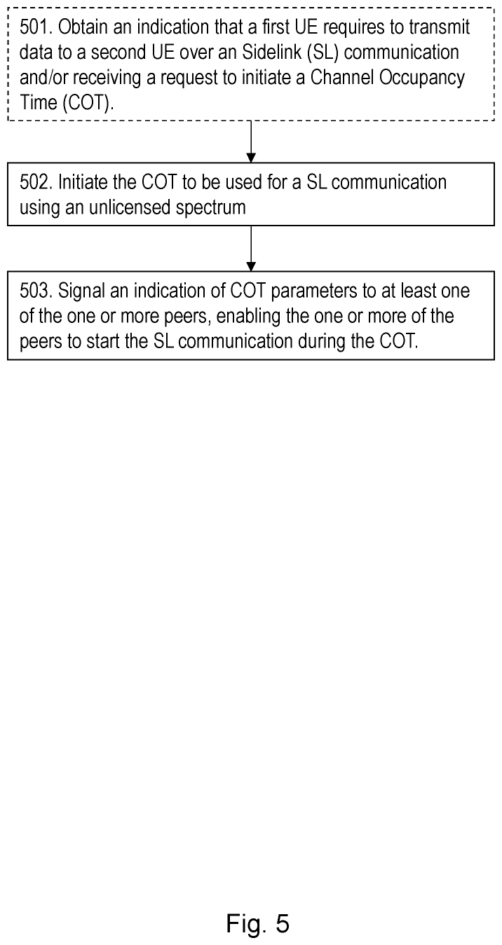

FIG. 5 shows an example method performed by the network node 110. The method is e.g., for handling an SL communication over an unlicensed spectrum between one or more peers in the wireless communications network 100. The one or more peers comprise at least the first UE 121 and the second UE 122. The SL communication over the unlicensed spectrum may e.g., be referred to as SL-U. The method may comprise any one or more out of the actions below. Optional actions are referred to as dashed boxes in FIG. 5. The following actions may be performed in any suitable order.

### Action 501

In some embodiments, the network node 110 obtains an indication that the first UE 121 requires to transmit data to the second UE 122 over an SL communication. This may e.g., be performed by receiving a request from any one or more out of the first UE 121 and the second UE 122. The request is requesting the network node 110 to initiate the COT.

For example, the network node 110 may receive an indication that any of the first UE 121 or the second UE 122 need to transmit over SL. The indication may be received in an SL request. The which request may e.g., indicate the need of the COT. In some embodiments, the network node 110 receives an explicit request to initiate and/or start the COT e.g., for the first UE 121 and/or the second UE 122. In some embodiments, the network node 110 is preconfigured and/or may deduce when to initiate the COT e.g., for the first UE 121 and/or the second UE 122. In some embodiments, any other network entity e.g., some other network node and/or UE such as e.g., of the one or more peers, may send the request and/or indicate that any of the first UE 121 and/or the second UE 122 want to communicate over SL during the COT for the unlicensed spectrum.

The request may be sent over any suitable channel such as e.g., on NR PUSCH/PUCCH or NR-U PUSCH/PUCCH, e.g., over UCI.

### Action 502

The network node 110 initiates a COT to be used for the SL communication. The COT may be a time period for performing SL communication using the unlicensed spectrum.

Initiating the COT may involve reserving, e.g., allocating, a certain time period for communication. This may be e.g., performed by first ensuring and/or determining that the unlicensed spectrum is free to use for an SL COT by means of any suitable method. The time period initiated for the COT may be determined by any suitable configuration, such as e.g., by a preconfigured parameter and/or by LBE/FBE COT parameters. The time period length may be any suitable time period, e.g., time periods used for UL/DL NR-U COTs.

In some embodiments, the initiating of the COT for the unlicensed spectrum is based on, and/or triggered by, the obtained indication and/or received request.

### Action 503

The network node 110 signals an indication of COT parameters to at least one of the one or more peers, e.g., any one or more out of the first UE 121 and the second UE 122. The signalling of the indication of COT parameters to the at least one of the one or more peers enables at least one of the one or more of the peers, e.g., the first UE 121 and/or the second UE 122, to start the SL communication during the COT e.g., based on access information indicated by the indication of COT parameters.

For example, the first UE 121 may use the COT parameters to start to transmit data to the second UE 122 over SL-U, e.g., for at least part of the duration of the COT. The second UE 122 may also transmit data to the first UE 121 over the SL-U, e.g., in another part of the duration of the COT. The transition between data transmission from the first UE 121 and the second UE 122 may be determined by the COT parameters, e.g., if and how to use LBT or e.g., if there are specific time slots for when specific UEs, e.g., the first UE 121 and/or the second UE 122 is to transmit data.

In some embodiments, the indication of COT parameters comprises an indication of a channel assessment procedure to use before communicating using the unlicensed spectrum during the COT. The channel assessment procedure may indicate how each respective UE, such as e.g., the first UE 121 and/or the second UE 122, shall determine when it is possible to transmit data on the SL-U, e.g., at a specific time during the COT, and/or whether or not there are other upcoming and/or ongoing data transmissions in the COT. In some of these embodiments, the channel assessment comprises any one out of:
e.g., Category 1, no LBT, e.g., with immediate transmission after a short switching gap time,
e.g., Category 2, use LBT without a random back-off, e.g., wherein a duration of time that the channel is sensed to be idle before the transmitting UE transmits is deterministic,
e.g., Category 3, LBT with random back-off using a contention window of fixed size,
e.g., Category 4, LBT with random back-off using a contention window of a variable size,
e.g., Category X, e.g., with a defined sensing time before transmission and with a defined switching gap time, e.g., different from Category 1.

E.g., for Category 1, no LBT may be used by, instead respective UEs, such as e.g., the first UE 121 and/or the second UE 122, may be informed of which of the UEs that starts transmission, such as the first UE 121, and that another UE such as the second UE 122 may respond immediately after a short switching gap time.

E.g., for Categories 2, 3 and 4, the first UE 121 and/or the second UE 122 are to perform LBT with a random back-off when assessing whether or not they may use the SL during the COT. For categories 3 and 4, the random-back off may be bounded by a contention window e.g., similar as for NR-U COT. The contention window may be fixed for category 3. The contention window may have a preconfigured size, which may be determined by the network node 110 and/or based on a generated random number e.g., similar as for NR-U COT. In some embodiments the boundary of the generated random number is preconfigured.

The contention window may be variable for category 4. The window may have a variable size that may be determined by the network node 110 and/or be based on a generated random number e.g., similar as for NR-U COT. In some embodiments the boundary of the generated random number may be dynamically determined by the network node 110.

E.g., for Category X, A UE, e.g., the first UE 121, may use a set sensing time before transmitting during the COT, e.g., when the channel is clear. Another UE, e.g., the second UE 122, may respond immediately after a set switching gap time. The set switching gap time may be different from the switching gap time of Category 1.

Additionally, or alternatively, the indication of the COT parameters may comprise an indication of any one or more out of:
An LBT category indicating how to perform for channel assessment. This may e.g., be for detecting presence of other UE's transmissions in the unlicensed spectrum, such as using e.g., no LBT, deterministic LBT, or a random backoff LBT.
LBE channel access parameters, e.g., similar as for NR-U COT.
FBE channel access parameters, e.g., similar as for NR-U COT.
FBE COT length, e.g., a size or time period of the frame in the FBE COT.
A switch between channel access mode of the COT. This may e.g., be between LBE and FBE, and associated switching time.
An indication of which node initiated the COT. This may e.g., be when the COT is an FBE COT.
Information about a CP extension. This information may, e.g., be used when communicating during the COT, e.g., for deciding whether or not to have a CP extension, e.g., which value of CP extension to have.
An Energy Detection, ED, threshold. The ED may e.g., be used for determining what interference is sufficient to determine that the unlicensed spectrum is clear and ready for transmission.

Signalling the indication of COT parameters may be referred to as an initiating signalling or initiation signalling.

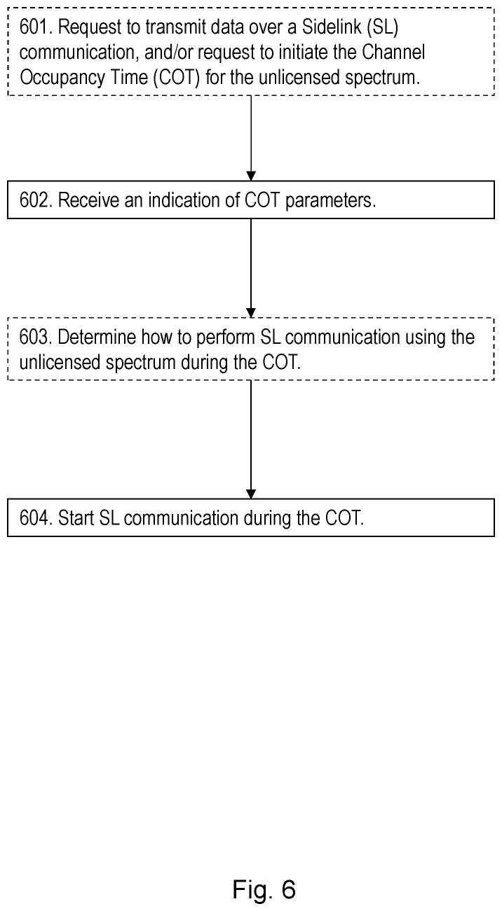

FIG. 6 shows an example method performed by a UE such as the first UE, 121 or second UE 122. In some embodiments all the method actions are performed by either the first UE 121 or the second UE 122. The method is e.g., for handling an SL communication over an unlicensed spectrum in the wireless communications network 100. The SL communication is between one or more peers comprising at least the first UE 121 and the second UE 122. The method may comprise any one or more out of the actions below. Optional actions are referred to as dashed boxes in FIG. 6. The following actions may be performed in any suitable order.

### Action 601

In some embodiments, the first UE 121 or the second UE 122 requests e.g., the network node 110, to initiate the COT for the unlicensed spectrum for SL communication over the unlicensed spectrum between the one or more peers.

In some embodiments, the first UE 121 or the second UE 122 may further request e.g., the network node 110, to transmit data to the first UE 121 or the second UE 122, over an SL communication.

For example, the first UE 121 or the second UE 122 may transmit an indication that any of the first UE 121 or the second UE 122 need to transmit over SL, e.g., by transmitting an SL request, e.g., which request may indicate the need of the COT. In some embodiments, the first UE 121 or the second UE 122 transmits an explicit request to initiate/start the COT e.g., for the first UE 121 and/or the second UE 122.

The request may be sent over any suitable channel such as e.g., on NR PUSCH/PUCCH or NR-U PUSCH/PUCCH, e.g., over UCI.

### Action 602

The first UE 121 or the second UE 122 receives, e.g., an indication of COT parameters. The indication of COT parameters may be received from the from the network node 110. Receiving the indication of the COT parameters may indicate that the network node 110 has initiated for SL-U transmission for the one or more peers during the COT. Receiving the indication of COT parameters enables the first UE 121 and/or the second UE 122 to start the SL communication during the COT. The COT may be a time period for performing SL communication using the unlicensed spectrum.

For example, the first UE 121 may use the COT parameters to start to transmit data to the second UE 122 over SL-U, e.g., for at least part of the duration of the COT. The second UE 122 may also transmit data to the first UE 121 over the SL-U, e.g., in another part of the duration of the COT. The transition between data transmission from the first UE 121 and the second UE 122 may be determined by the COT parameters, e.g., if and how to use LBT or e.g., if there are specific time slots for when specific UEs, e.g., the first UE 121 and/or the second UE 122 is to transmit data.

In some embodiments, the indication of COT parameters comprises an indication of a channel assessment procedure to use before communicating using the unlicensed spectrum during the COT. The channel assessment procedure may indicate how the first UE 121 and/or second UE 122, e.g., or any other UE in the one or more peers, shall determine when it is possible to transmit data on the SL-U, e.g., at a specific time during the COT, e.g., whether or not there are other upcoming and/or ongoing data transmissions in the COT. In some of these embodiments, the channel assessment comprises any one out of:
e.g., Category 1, no LBT, e.g., with immediate transmission after a short switching gap time,
e.g., Category 2, use LBT without a random back-off, e.g., wherein a duration of time that the channel is sensed to be idle before the transmitting entity transmits is deterministic,
e.g., Category 3, LBT with random back-off using a contention window of fixed size,
e.g., Category 4, LBT with random back-off using a contention window of a variable size,
e.g., Category X, e.g., with a defined sensing time before transmission and with a defined switching gap time, e.g., different from Category 1,

E.g., for Category 1, no LBT may be used by. Instead respective UEs may be informed about, also referred to as informed of, which UE that starts transmission such as the first UE 121, and that another UE such as the second UE 122 may respond immediately after a short switching gap time.

E.g., for Categories 2, 3 and 4, the first UE 121 and/or the second UE 122 are to perform LBT with a random back-off when assessing whether or not they may use the SL during the COT. For categories 3 and 4, the random-back off may be bounded by a contention window e.g., similar as for NR-U COT. The contention window may be fixed for category 3, e.g., the window has a preconfigured size, e.g., determined by the network node 110 and/or based on a generated random number e.g., similar as for NR-U COT. In some embodiments the boundary of the generated random number is preconfigured.

The contention window may be variable for category 4, e.g., the window has a variable size e.g., determined by the network node 110 and/or based on a generated random number e.g., similar as for NR-U COT. In some embodiments the boundary of the generated random number is dynamically determined e.g., by the network node 110.

E.g., for Category X, A UE, e.g., the first UE 121 may use a set sensing time before transmitting during the COT, e.g., when the channel is clear. Another UE, e.g., the second UE 122 may respond immediately after a set switching gap time. The set switching gap time may be different from the switching gap time of Category 1.

Additionally, or alternatively, the indication of the COT parameters may comprise an indication of any one or more out of:
an LBT category indicating how to perform for channel assessment, e.g., for detecting presence of other UE's transmissions in the unlicensed spectrum, such as using e.g., no LBT, deterministic LBT, or a random backoff LBT,
LBE channel access parameters, e.g., similar as for NR-U COT,
FBE channel access parameters, e.g., similar as for NR-U COT,
an FBE COT length, e.g., a size or time period of the frame in the FBE COT,
a switch between channel access mode of the COT, e.g., between LBE and FBE, e.g., and associated switching time,
an indication of which node initiated the COT, e.g., when the COT is an FBE COT,
information about a CP extension, e.g., to be used when communicating during the COT, e.g., whether or not to have a CP extension or not, e.g., which value of CP extension to have, and
an Energy Detection, ED, threshold, e.g., for determining what interference is sufficient to determine that the unlicensed spectrum is clear and ready for transmission.

### Action 603

In some embodiments, the first UE 121 or the second UE 122 determines how to perform SL communication using the unlicensed spectrum during the COT based on the COT parameters. In some embodiments some of the configurations to be used are indicated by the COT parameters. In some embodiments some of the configurations to be used are preconfigured or indicated by other suitable means. In some embodiments, performing the SL communication using the unlicensed spectrum during may comprise transmitting and/or receiving SL data e.g., between the one or more peers such as e.g., the first UE 121 and/or the second UE 122.

In some embodiments, the first UE 121 or the second UE 122 determines how to perform SL communication using the unlicensed spectrum during the COT by determining a channel assessment procedure to use before communicating using the unlicensed spectrum during the COT. The channel assessment procedure may relate to e.g., if, and/or how to perform LBT, e.g., which LBT category to use, e.g., as described in Action 602, e.g., as indicated by the COT parameters and/or indicated by other suitable means.

### Action 604

The first UE 121 or the second UE 122 starts the SL communication during the COT. Starting the SL communication during the COT may be based on access information indicated by the indication of COT parameters. Since the first UE 121 and/or the Second UE 122 is informed of how to perform SL communication, e.g., as determined in Action 603 and/or indicated at least partially by the COT parameters, the first UE 121 or second UE 122 may in some embodiments immediately start to communicate using the SL-U during the COT. For example, the first UE 121 or the second UE 122 may have determined, and/or the COT parameters may have indicated, that the first UE 121 or the second UE 122 are selected to transmit data, e.g., during a first period, when the COT starts. In some embodiments, LBT is only needed for data transmissions subsequent to the data transmission which starts the SL-U transmission during the COT.

The method will now be further explained and exemplified in below embodiments. These below embodiments may be combined with any suitable embodiment as described above.

### Example Scenarios

In any of below examples, the following assumptions may be valid when suitable.
When the term node is used below, the node may be any of the network node 110 or any of the one or more peers such as the first UE 121 or the second UE 122.
The information in Downlink Control Information (DCI), Radio Resource Control (RRC), System Information Block (SIB), Master Information Block (MIB), etc. may be sent over licensed and/or unlicensed spectrum, e.g., any one or more out of the information communicated in Actions 501, 503, 601 and 602 above. Note, in some embodiments, when the signalling is itself initiation signalling, then signalling may occur in the unlicensed or license-exempt spectrum.
One or more peers, e.g., a pair of UEs, e.g., the first UE 121 and the second UE 122, may have transmission needs over SL. When the resource, e.g., frequency spectrum, is unlicensed, we define access behaviour as in any one or more of the below embodiments and/or examples.
The resource may be TDD, FDD, or any suitable division of time and/or frequency for communication.
The unlicensed resource may be in any unlicensed band, e.g., 2.5 GHZ, 5 GHz, 6 GHZ, FR1, FR2, 52.6 GHZ-71 GHz, or any frequency above 100 GHz. In some embodiments, any frequencies may be part of embodiments herein, in particular when they may be used for SL transmission and e.g., when these frequencies are not licensed e.g., or otherwise reserved for other purposes which would cause interference.

In below examples and embodiments, the network node 110 may be a gNB. In below examples and embodiments, the referenced UE #1, UE #2, UE #3, and UE #4 may each respectively be any one of the one or more peers, such e.g., the first UE 121 or the second UE 122.

### EXAMPLES

Below follows a series of example embodiments which may all respectively be combined with any of each other and/or with the above method actions, and/or with any of the embodiments herein.

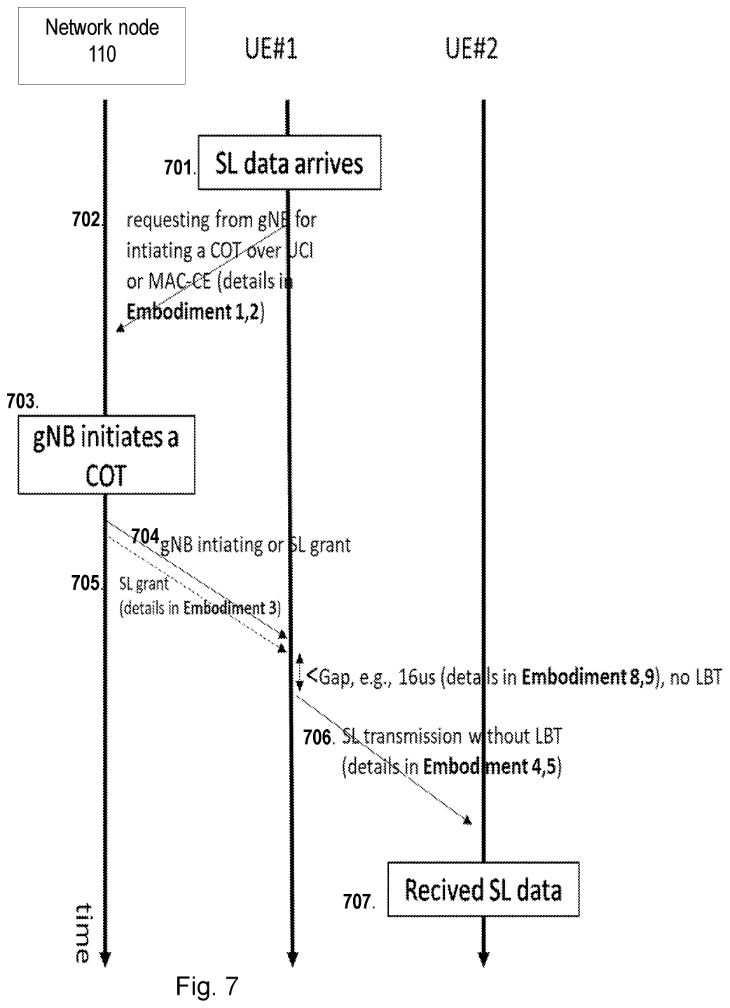

In FIGS. 7-9 and other examples below, the network node 110 may in some places be referred to as gNB, the first UE 121 is referred to as UE #1, and the second UE 122 is referred to as UE #2.

An example is given in FIG. 7. Data arrives 701 at UE #1, e.g., for SL transmission to UE #2. Next, the UE #1 requests 702, the network node 110 to initiate a COT. This is e.g., related to actions 501, 601 above. This request may be sent over UCI as an example, other cases are also discussed in below Example 2. Next, the network node 110 initiates 703 a COT e.g., related to action 502 above. The network node 110 may assign an SL grant and transmit 704 initiating signalling and/or transmit 705 an SL grant. This is e.g., related to actions 502, 503, 602 above. In this example the SL grant and initiating signalling may be combined into one DL DCI signalling, other cases are discussed in below Example 3. After initiating signalling, UE #1 may start 706 transmission e.g., without LBT if the transmission starts not later than the defined Gap (e.g., 9 micro sec) after receiving the network node 110 initiating signal. E.g., with more details in below Example 4. This may be related to actions 603, 604 above. The UE #2 may further receive 707 the SL data transmitted by the UE #1.

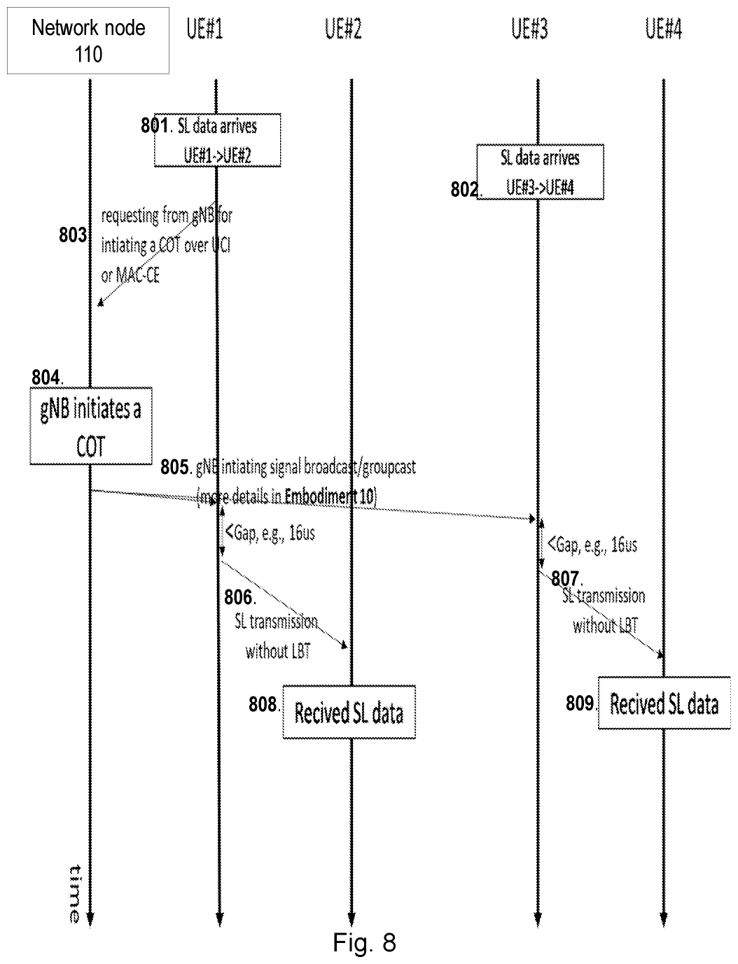

In another example, illustrated in FIG. 8, the network node 110 initiating signalling may be broadcasted or group-casted to a group of UEs. In this example, the network node 110 controls the resources for SL transmissions between UE #1 and UE #2 and the transmission between UE ##and UE #4. They may e.g., be in different frequency resources, in order not to have collision on their transmissions. More details are discussed in below Example 10.

In the example illustrated in FIG. 8, the SL data for UE #2 arrives 801 at UE #1. In this example, the SL data for UE #4 arrives 802 at UE #3. The UE #1 requests 803 for the network node 110 to initiate signalling by UCI, and UE #3 is configured to be initiated with a COT without sending a COT request to the network node 110. The network node 110 initiates 804 a COT of the SL-U. UE #1 and UE #2 may use one set of frequencies and UE #1 and UE #2 use another set of frequencies. This may e.g., be related to action 502 above. In this example, the network node 110 broadcasts 805 an initiating signal, e.g., indicating the COT and/or the COT parameters. This may e.g., be related to actions 503, and 602 above. In this example, the UE #1 performs 806 an SL transmission without LBT (after a gap) to the UE #2. This may e.g., be related to actions 603, 604 above. In this example, the UE #3 performs 807 an SL transmission without LBT (after a gap) to the UE #4 e.g. This may e.g., be related to actions 603, and 604 above. In this example, the UE #2 receives 808 the SL data and the UE #4 receives 809 the SL data.

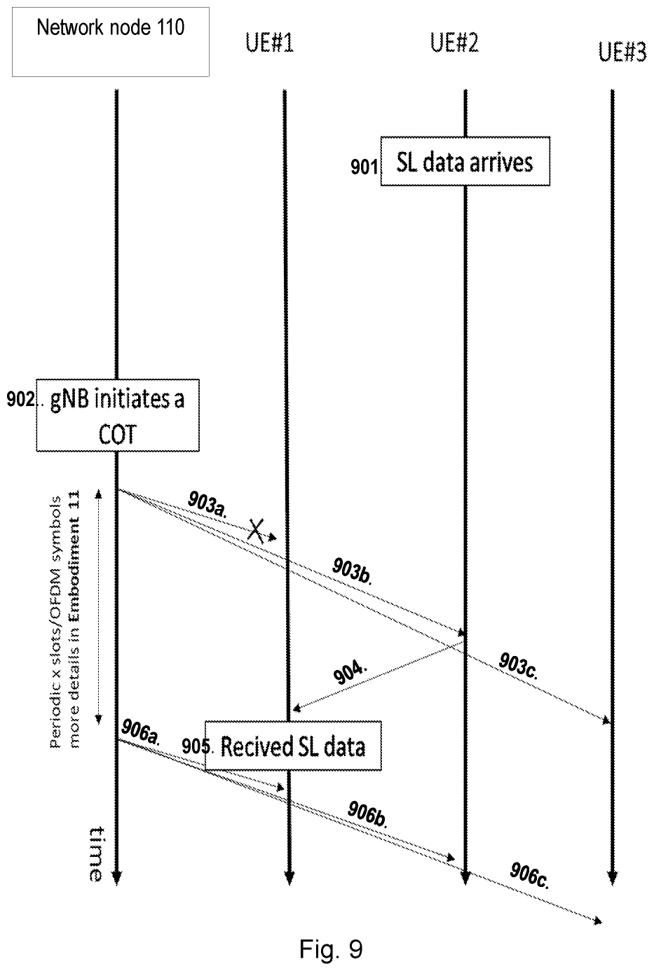

In another example, illustrated in FIG. 9, the network node 110 initiating signalling is transmitted periodically by the network node 110. In this example, the UE #1 does not receive an initiating signal, and thus it cannot transmit SL data. However, UE #2 receives the initiating signal and can transmit its SL data. In this example, the SL data arrives 901 at UE #2 and the network node 110 initiates 902 a COT of the SL-U. This may e.g., be related to action 502 above. In this example, the network node 110 may transmit 903a an initiating signal to UE #1 which is not received by UE #1. The network node 110 may transmit 903b an initiating signal to UE #2 which is received by UE #2. The network node 110 may transmit 903c an initiating signal to UE #3 which is received by UE #3. Actions 903a-903c may e.g., relate to actions 503, 602 above. In this example, the UE #2 may transmit 904 the SL data to the UE #1, which e.g., may be related to actions 603, 604 above. The UE #1 receives 905 the SL data. The network node 110 may again transmit initiating signalling, e.g., periodically. The network node 110 may transmit 906a an initiating signal to UE #1 which is received by UE #1. The UE #1 may now in some embodiments be enabled to transmit its SL data. The network node 110 may transmit 906b an initiating signal to UE #2 which is received by UE #2. The network node 110 may transmit 906c an initiating signal to UE #3 which is received by UE #3. Actions 906a-906c may e.g., relate to actions 503, 602 above.

Example 1) For a given SL communication over an unlicensed spectrum, e.g., between UE #1 and UE #2, the network node 110 may initialize a COT for these UEs, e.g., as in Action 602 above, which in this example enables the UE #1 and the UE #2 to communicate over SL using scheduled and/or configured resources during a COT initialized by the network node 110.
a. In other words, in this example, the network node 110 initializes a SL COT.
b. The initiating signalling to initiate the SL COT from network node 110 may be performed using any suitable channel e.g., PDSCH, PDCCH, Group Common PDCCH (GC-PDCCH), and/or performed by any suitable signalling such as Demodulation Reference Signal (DMRS) transmission signalling, reference signal transmission, or orphan symbol transmission. These example transmissions are meant for any UE in the one or more peers such as e.g., the first UE 121 or second UE 122.
C. For a given SL communication over unlicensed spectrum, e.g., between UE #1 and UE #2, the network node 110 provides parameters on channel access mode e.g., FBE or LBE, via signalling alternatives such as SIB, MIB, RRC, or DCI, to both or either UE, e.g., the first UE 121 and/or the second UE 122.
d. In one option, a UE, e.g., the first UE 121 and/or the second UE 122, sends a request to the network node 110 to initiate the SL COT, meant for SL transmission. The request may be performed on NR PUSCH/PUCCH or NR-U PUSCH/PUCCH. In other words, over licensed or unlicensed spectrum.
e. In one option, the network node 110 initiates the SL COT without reception of a request from a UE, e.g., the first UE 121 and/or the second UE 122. In this case, the network node 110 may already have information available on whether the UE, e.g., the first UE 121 and/or the second UE 122, needs to transmit data over SL to another UE, e.g., the first UE 121 and/or the second UE 122. The information may be obtained by the network node 110 itself. In an example, the network node 110 deduces the information based on a previous request for COT initiation, and/or a previous report message from a UE, e.g., the first UE 121 and/or the second UE 122. and/or monitoring of UE transmission activities. In another example, the network node 110 obtains the information on the UE, e.g., the first UE 121, from another UE, e.g., the second UE 122. The other UE may in this example have the information on the UE. Therefore, the other UE may report the information to the network node 110.

Example 2) The signalling from UE's requesting from network node 110 about initiating a COT, e.g., as in Action 601 and 501, may be sent over UCI or MAC-CE, e.g., which may be transmitted in PUCCH or PUSCH channels. For the UE's requesting COT initiation, either a new field in UCI or MAC-CE may be defined or already existing fields in UCI or MAC-CE may be repurposed. In one option, the UE's requesting for COT initiation, signalling may be combined with a UE request for SL grant, e.g., in case of dynamic SL assignment in Mode 1 SL operation.

Example 3) When the network node 110 performs initiation signalling, e.g., as in Action 503 above, e.g., the signalling may be combined with DCI for SL assignment or transmitted separately using different resources, e.g., time and/or frequency resources. In the combined case, in one option, the DCI for SL grant may be used by the network node 110, e.g., to indicate the COT and/or COT parameters to the first UE 121 and/or the second UE 122. In another option, the DCI for SL grant may be combined with SL COT information, e.g., when indicating COT parameters, e.g., as in Action 503 above.

Example 4) For dynamic SL grants, the network node 110 indicates, e.g., when signalling COT parameters as in action 503 above, FBE COT initiation information in the DCI, e.g., comprising whether the COT is initiated by network node 110 or another node, or not. The FBE COT information may comprise, e.g., as for NR-U, information of how to perform a clear channel assessment per a fixed frame period of the FBE. Additional information may be included about an LBT Type to use, e.g., LBT CAT 1, LBT CAT 2, whether to use 0 or 9 us sensing. Additional information may be included about the Cyclic prefix (CP) type for the transmission.

Example 5) For configured SL grants, e.g., Type 1 or Type 2, the network node 110 may determine whether an FBE COT is initiated by the network node 110 or not. This may e.g., depend on the pattern of configured SL grant, or its periodicity. In one example, e.g., if the configured grant resource is repeated after an idle period, the network node 110 may not initiate the COT. In another example, when one or more transmissions or repetitions from a HARQ process are spilling over from a previous COT to a next COT, e.g., immediately after an idle period, the network node 110 may not initiate the COT. In other words:
a. When a DL resource and a configured grant resource do not overlap in a COT, the network node 110 may initiate that COT e.g., as in Actions 502-503 above.
b. When a DL resource configured grant resource overlap in the COT, the network node 110 may:
i. Not transmit COT initiation signalling, e.g., as in Action 503 above. E.g., meaning that the COT is not initiated, and UE #1 may be unable transmit on configured grant on the COT,
ii. Transmit COT initiating signalling, e.g., as in Action 503 above, e.g., where a UE, e.g., the first UE 121 or the second UE 122, may not transmit on the overlapping part where it is supposed to receive COT initiating signalling, e.g., using DL signalling. The UE, e.g., the first UE 121 or the second UE 122, may then transmit on the remaining CG resources e.g., on the remaining repetitions or remaining part of a nominal repetition, wherein a nominal repetition may be broken to multiple actual repetitions where repetitions are performed using valid resources e.g., as with PUSCH Type B repetition. The transmissions or repetitions may be performed over the remaining resources by rate matching or puncturing.

Example 6) In one example, the network node 110 may send SIB, MIB, or scheduling DCI, e.g., DCI format 3-x, DCI over GC-PDCCH e.g., to UE #1 and UE #2, indicating any one or more out of, e.g., as discussed in Action 503 above:
a. one or more LBE channel access parameters, such as any one or more of: priority class, a CW window, e.g., contention window, CP extension,
b. one or more FBE channel access parameters,
c. a FBE COT length,
d. Switching between LBE/FBE modes,
e. Information about FBE COT initiation node, e.g, whether it is network node 110 or some other node,
f. Information about an CP extension, and
g. an ED threshold.

Example 7) In one example, the network, e.g., the network node 110 or some other network node in the wireless communications network 100, may define a FBE COT initiating behaviour. E.g., network node 110 initiated COT behaviour for Mode 1 SL and/or Mode 2 SL. For Mode 1, both dynamic and/or configured grants may be considered, e.g., used for signalling the indication of COT parameters. For Mode 2, configured grants may be considered e.g., used for signalling the indication of COT parameters.

Example 8) In mode 1 SL, SL grants may be granted by network node 110 to an SL transmitter. Hence, in these SL grants, network node 110 may indicate channel access information, e.g., an LBT type to use in FBE or LBE mode.
a. For example, in FBE mode, network node 110 may indicate whether it is Cat. 1 or Cat. 2 or some new type, let us say, Cat. X e.g., as in Action 503 above. In other examples, there may be no sensing time, e.g., if gap is <=16 us. In Cat 2, a gap may be >=25 us and e.g., 9 us sensing may be required before performing or starting SL transmission. In Cat. X, we may define a gap of at least G1 us, and S1 us sensing required before transmission. The behaviour may be coupled with a network node 110-COT initiation behaviour, but it may also be coupled with some other node initiation COT behaviour. In other words, the channel assessment type to use may be based on which network node, or which type of network node initiates the COT.

Example 9) In mode 2 SL, network node 110 may not provide dynamic SL grants. In these embodiments, the network node 110 may use some DL signalling, e.g., which need not to be dynamic grants, for initiating FBE COT for, e.g., the first UE 121 or the second UE 122 UEs. For example, some signalling which may be used are described in Example 3, such as orphan symbol transmission, DMRS, reference signal transmission.
a. However, in this FBE COT, an SL transmitter UE, e.g., the first UE 121 or the second UE 122, may autonomously select a resource for a SL transmission. In these embodiments, the UE must perform the required LBT category type, e.g., in FBE mode, e.g., CAT 1, CAT 2 or CAT X, before transmitting the SL transmission, e.g., depending on a defined gap between the SL transmission and the previous transmission in the COT. The previous transmission in the COT may be any one or more of a DL transmission from network node 110, e.g., including COT initiation or non-initiation transmission, an SL transmission, or any other identifiable transmission.
b. As in option a., the SL UE, e.g., the first UE 121 or the second UE 122, may determine an LBT category/type depending on the understanding of gap by itself. Thus, the rules for LBT category type may be specified in RRC or sent to the SL UE in a-priory manner, e.g., in SIB or some DCI. The rules may specify, what (a) sensing period should be used and (b) what is the gap period where this sensing period is utilized, e.g., where CAT 1 or CAT2 2 or CAT X applies.

Example 10) In one example, the network node 110 may send the initiating signal e.g., as in Action 503 above, to more than one UE, e.g., to any of the one or more peers. Different options may exist here:
a. In one option, the network node 110 may broadcast the network node 110 initiating signal, e.g., the indication of the COT parameters, to all the UEs under its coverage.
b. In another option, the network node 110 may group-cast, e.g., using GC-PDCCH, the initiating signal to a group of UEs.
c. In another option, the network node 110 initiated COT may be used by a UE, e.g., the first UE 121 or the second UE 122, with a specific category or a UE with specific capabilities.
d. In another option, the network node 110 initiated COT may be used for a specific service and/or traffic type, e.g., for URLLC traffic.
e. In another option, the network node 110 initiated COT may be used only for control transmission.
f. In another option, the network node 110 initiated COT may be used only for data transmission.
g. In another option, the network node 110 initiated COT may be shared by the nodes performing a specific channel access category e.g., Type 1, Type 2 Channel access category, or channel access priority class.
h. For all the above options, the information about which UEs to use the network node 110 initiated COT, and/or which service type, may be communicated by the network node 110 through RRC configuration, or communicated dynamically through DCI.
For different Modes SL of operation, the network node 110 may perform different priori actions to avoid collision between SL transmissions in the same COT. The actions may be listed for different Modes of SL operations, e.g., as follows:
i. In Mode 1 SL resource allocation: SL transmission may be under the control of the network node 110. The network node 110 may assign resources such that collision is avoided. Mode 1 may be both dynamic scheduling or configured scheduling, i.e., CG Type 1 and CG Type 2.
j. In Mode 2 SL resource allocation: UE, e.g., the first UE 121 or the second UE 122, may decide to transmit on the resources, e.g., selected by itself.

Example 11) In another example, the network node 110 initiating COT signalling e.g., as in Action 503 above, may be transmitted periodically e.g., every x slots and/or OFDM symbols by network node 110 to a group of UEs, e.g., the one or more peers. In some embodiments, the UEs that received the COT initiating signalling may use the COT and start transmission, e.g., immediately and/or by using the channel assessment procedure indicated by the COT parameters.

Example 12) In one example, SL UEs e.g., the first UE 121 or the second UE 122, may be defined with one or more different and multiple FBE COTs. Further, the network, e.g., the network node 110 or some other network node in the wireless communications network 100 may define a COT initiation behaviour, e.g., for which node initiates the COT and/or for each COT and indicate such information in RRC or via DCI.

Example 13) In one example, the network node 110 initializes a current SL COT for FFP ID #F1 for SL pair UE #1 and UE #2 communication, e.g., as in Action 502 above. In the initiation signalling, e.g., sent in the COT of FFP ID #F1, e.g., as in Action 503 above, the network node 110 may also indicate information about the suspension of any one or more out of:
a. a remaining or part of remaining COT, e.g., last T symbols or last T slots of the COT, after a specific SL transmission, or after the initiation signalling, e.g., as in Action 503, e.g., in the same COT, or
b. the next COT, or next N consecutive COTs, or next N COTs with any pattern,
c. until a certain time, and
d. COTs of some other FFP, say FFP ID #F2.

Example 14) The above and/or below examples may be replicated for any embodiment comprising/using an LBE COT.

Example 15) In one example, when a UE, e.g., the first UE 121 or the second UE 122, is configured with two COTs, where one COT is for sending/receiving uu interface based transmissions, e.g., UL and DL, and the other COT is for sending/receiving SL transmissions, e.g., as in Actions 501-503 and 601-604 above, any one or more of the following may be part of embodiments herein:
a. Both COTs may be initiated by a same DL signalling from the network node 110. These embodiments mean that both COT may overlap in such a manner where the network node 110 may initialize both COTs by sending the same signalling at the same time. In the signalling, e.g., as in Action 503 above, the network node 110 may mention parameters for Uu COT and/or SL COT, e.g., access profile, CP extension, COT priority, etc.
b. Both COTs may be LBE or FBE based. In some embodiments one COT is LBE based and the other is FBE based.

Example 16) A UE, e.g., the first UE 121 or the second UE 122, may be configured with a COT, e.g., FBE or LBE, wherein the COT may be allocated over PDSCH and/or PUSCH and/or Sidelink Shared Channel (SLSCH) and/or PDCCH and/or PUCCH and/or Sidelink Control Channel (SLCCH). In some embodiments, restriction of COT initiating, or COT sharing may be imposed if the COT is allowed to be initiated by the network node 110 or some other node.

Example 17) This may be an extension of example 15, e.g., where a UE, e.g., the first UE 121 or the second UE 122, may be allocated a COT/FFP, and in the same COT, any one or more applies:
a. the UE is configured to transmit
   i. one or more UL transmissions with FBE and SL transmissions with LBE mode, or
   ii. one or more UL transmissions with LBE and SL transmissions with FBE mode,
b. the information related to where the UE chooses what access mode, e.g., LBE or FBE, for the given transmission e.g., any of PUSCH, SLSCH, PUCCH, and SLCCH, may be indicated in RRC, SIB and/or scheduling DCI for dynamic allocation/activation DCI for periodic allocation. This may be different from example 16 where all type of transmissions are performed either with LBE or FBE mode.

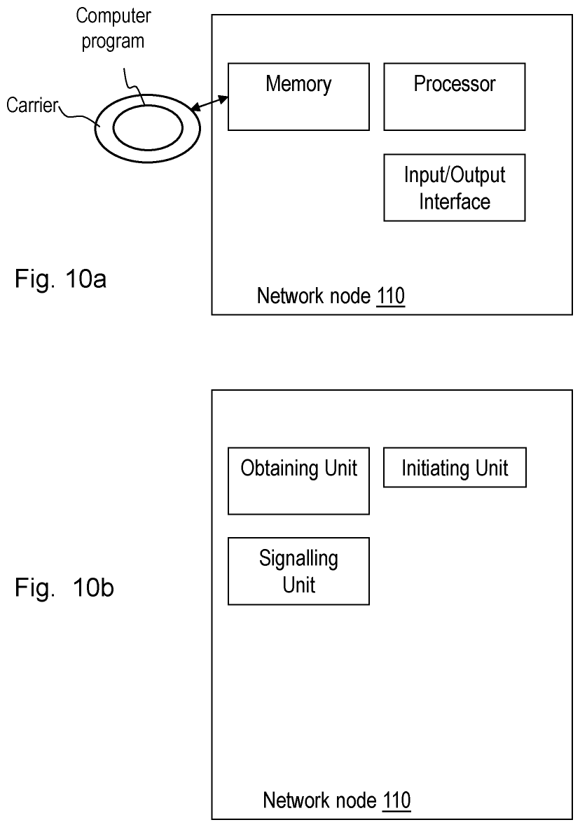

FIGS. 10a and 10b show examples of an arrangement in the network node 110.

The network node 110 may comprise an input and output interface 1000 configured to communicate e.g., with any of the networking entities operating in the wireless communications network 100 of embodiments herein such as e.g., the network node 110. The input and output interface 1000 may comprise a receiver, e.g., wired and/or wireless, (not shown) and a transmitter, e.g., wired and/or wireless, (not shown).

The network node 110 may comprise any one or more out of: a obtaining unit, a initiating unit, and a signalling unit to perform the method actions as described herein, e.g., actions 501-503 above.

The embodiments herein may be implemented through a respective processor or one or more processors, such as at least one processor 1060 of a processing circuitry in the network node 110 depicted in FIG. 10a, together with computer program code for performing the functions and actions of the embodiments herein. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a memory 1070 comprising one or more memory units. The memory 1070 comprises instructions executable by the processor in the network node 110. The memory 1070 is arranged to be used to store instructions, data, configurations, measurements, COT parameters, and applications to perform the methods herein when being executed in the network node 110.

In some embodiments, a computer program 1080 comprises instructions, which when executed by the at least one processor 1060, cause the at least one processor 1060 of the network node 110 to perform the actions above.

In some embodiments, a respective carrier 1090 comprises the respective computer program 1080, wherein the carrier 1090 is one of an electronic signal, an optical signal, an electromagnetic signal, a magnetic signal, an electric signal, a radio signal, a microwave signal, or a computer-readable storage medium.

Those skilled in the art will also appreciate that the functional modules in the network node 110, described below may refer to a combination of analog and digital circuits, and/or one or more processors configured with software and/or firmware, e.g., stored in the network node 110, that when executed by the respective one or more processors such as the at least one processor 1060 described above cause the respective at least one processor 1060 to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

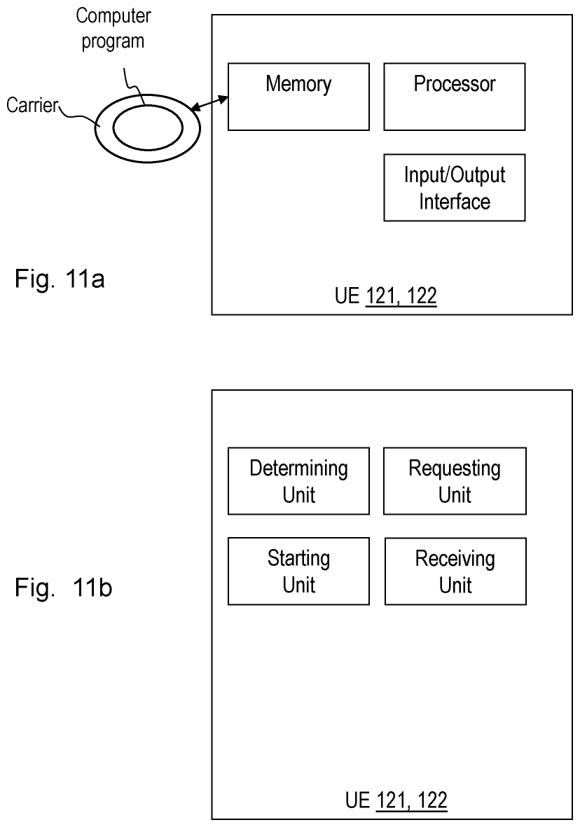

FIGS. 11a and 11b show examples of an arrangement in the first UE 121 or second UE 122.

The first UE 121 or second UE 122 may comprise an input and output interface 1100 configured to communicate e.g., with any of the networking entities operating in the wireless communications network 100 of embodiments herein, such as e.g., the first UE 121. The input and output interface 1100 may comprise a receiver, e.g., wired and/or wireless, (not shown) and a transmitter, e.g., wired and/or wireless, (not shown).

The first UE 121 or second UE 122 may comprise any one or more out of: a determining unit, a requesting unit, a receiving unit, and a starting unit to perform the method actions as described herein, e.g., actions 601-604 above.

The embodiments herein may be implemented through a respective processor or one or more processors, such as at least one processor 1160 of a processing circuitry in the first UE 121 or second UE 122 depicted in FIG. 11a, together with computer program code for performing the functions and actions of the embodiments herein. The program code mentioned above may also be provided as a computer program product, for instance in the form of a data carrier carrying computer program code for performing the embodiments herein when being loaded into the first UE 121 or second UE 122. One such carrier may be in the form of a CD ROM disc. It is however feasible with other data carriers such as a memory stick. The computer program code may furthermore be provided as pure program code on a server and downloaded to the first UE 121 or second UE 122.

The first UE 121 or second UE 122 may further comprise a memory 1170 comprising one or more memory units. The memory 1170 comprises instructions executable by the processor in the first UE 121 or second UE 122. The memory 1170 is arranged to be used to store instructions, data, configurations, COT parameters, and applications to perform the methods herein when being executed in the first UE 121 or second UE 122.

In some embodiments, a computer program 1180 comprises instructions, which when executed by the at least one processor 1160, cause the at least one processor 1160 of the first UE 121 or second UE 122 to perform the actions above.

In some embodiments, a respective carrier 1190 comprises the respective computer program 1180, wherein the carrier 1190 is one of an electronic signal, an optical signal, an electromagnetic signal, a magnetic signal, an electric signal, a radio signal, a microwave signal, or a computer-readable storage medium.

Those skilled in the art will also appreciate that the functional modules in the first UE 121 or second UE 122, described below may refer to a combination of analog and digital circuits, and/or one or more processors configured with software and/or firmware, e.g., stored in the first UE 121 or second UE 122, that when executed by the respective one or more processors such as the at least one processor 1160 described above cause the respective at least one processor 1160 to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

The embodiments herein are not limited to the above described preferred embodiments. Various alternatives, modifications and equivalents may be used.

Below, some example embodiments 1-24 are shortly described. See e.g., FIGS. 5, 6, 7, 8, 9, 10a, 10b, 11a, and 11b.

Embodiment 1. A method performed by a network node 110 e.g., for handling a Side Link, SL, communication over an unlicensed spectrum, between one or more peers comprising at least a first User Equipment, UE, 121 and a second UE 122 in a wireless communications network 100, the method e.g., comprising any one or more out of:
initiating 502 a Channel Occupancy Time, COT, to be used for the SL communication, e.g., wherein the COT is a time period for performing SL communication using the unlicensed spectrum, and
signalling 503 an indication of COT parameters to at least one of the one or more peers, e.g., any one or more out of the first UE 121 and the second UE 122, enabling at least one of the one or more of the peers, e.g., the first UE 121 and/or the second UE 122, to start the SL communication during the COT e.g., based on access information indicated by the indication of COT parameters.

Embodiment 2. The method according to Embodiment 1, wherein the method further comprises e.g., any one or more out of:
obtaining, 501 an indication that the first UE 121 requires to transmit data to the second UE 122 over an SL communication, e.g., by receiving a request from any one or more out of the first UE 121 and the second UE 122, e.g., requesting the network node 110 to initiate the COT, and wherein
initiating 502 the COT for the unlicensed spectrum is based on, and/or triggered by, the obtained indication or received request.

Embodiment 3. The method according to any of Embodiments 1-2, wherein the indication of COT parameters comprises an indication of a channel assessment procedure to use before communicating using the unlicensed spectrum during the COT, e.g., wherein the channel assessment comprises any one out of:
e.g., Category 1, no LBT, e.g., with immediate transmission after a short switching gap time,
e.g., Category 2, use LBT without a random back-off, e.g., wherein a duration of time that the channel is sensed to be idle before the transmitting UE transmits is deterministic,
e.g., Category 3, LBT with random back-off using a contention window of fixed size,
e.g., Category 4, LBT with random back-off using a contention window of a variable size,
e.g., Category X, e.g., with a defined sensing time before transmission and with a defined switching gap time, e.g., different from Category 1.

Embodiment 4. The method according to any of Embodiments 1-3, wherein the indication of the COT parameters comprises an indication of any one or more out of:
an LBT category indicating how to perform for channel assessment, e.g., for detecting presence of other UE's transmissions in the unlicensed spectrum, such as using e.g., no LBT, deterministic LBT, or a random backoff LBT,
Load Based Equipment, LBE, channel access parameters,
Frame Based Equipment, FBE, channel access parameters,
FBE COT length, e.g., size of frame,
a switch between channel access mode of the COT, e.g., between LBE and
an indication of which node initiated the COT, e.g., when the COT is an FBE COT,
information about CP extension and
an Energy Detection, ED, threshold.

Embodiment 5. A computer program comprising instructions, which when executed by a processor, causes the processor to perform actions according to any of the Embodiments 1-4.

Embodiment 6. A carrier comprising the computer program of Embodiment 5, wherein the carrier is one of an electronic signal, an optical signal, an electromagnetic signal, a magnetic signal, an electric signal, a radio signal, a microwave signal, or a computer-readable storage medium.

Embodiment 7. A method performed by a first User Equipment, UE, 121 or second UE 122 e.g., for handling a Side Link, SL, communication over an unlicensed spectrum, between one or more peers comprising at least the first UE 121 and the second UE 122 in a wireless communications network 100, the method e.g., comprising any one or more out of:
receiving 602, e.g., from the network node 110, an indication of Channel Occupancy Time, COT, parameters, e.g., enabling the first UE 121 and/or the second UE 122 to start the SL communication during the COT, e.g., wherein the COT is a time period for performing SL communication using the unlicensed spectrum,
starting 604 the SL communication during the COT e.g., based on access information indicated by the indication of COT parameters.

Embodiment 8. A method according to Embodiment 7, further comprising:
based on the COT parameters, determining 603 how to perform SL communication using the unlicensed spectrum during the COT, e.g., for transmitting and/or receiving SL data e.g., between the one or more peers.

Embodiment 9. A method according to any of Embodiments 7-8, further comprising:
requesting 601, e.g., the network node 110, e.g., to transmit data to the first UE 121 or the second UE 122, over an SL communication, and/or to initiate the COT for the unlicensed spectrum, e.g., for SL communication over the unlicensed spectrum between the one or more peers.

Embodiment 10. The method according to any of Embodiments 7-9, wherein determining 603 how to perform SL communication using the unlicensed spectrum during the COT, comprises determining a channel assessment procedure to use before communicating using the unlicensed spectrum during the COT, e.g., if, and/or how to perform Listen Before Talk, LBT, e.g., which LBT category to use.

Embodiment 11. The method according to any of Embodiments 7-10, wherein the indication of COT parameters comprises an indication of a channel assessment procedure to use before communicating using the unlicensed spectrum during the COT, e.g., wherein the channel assessment comprises any one out of:
e.g., Category 1, no LBT, e.g., with immediate transmission after a short switching gap time,
e.g., Category 2, use LBT without a random back-off, e.g., wherein a duration of time that the channel is sensed to be idle before the transmitting entity transmits is deterministic,
e.g., Category 3, LBT with random back-off using a contention window of fixed size,
e.g., Category 4, LBT with random back-off using a contention window of a variable size,
e.g., Category X, e.g., with a defined sensing time before transmission and with a defined switching gap time, e.g., different from Category 1,
Embodiment 12. The method according to any of Embodiments 7-11, wherein the indication of the COT parameters comprises an indication of any one or more out of:
an LBT category indicating how to perform for channel assessment, e.g., for detecting presence of other UE's transmissions in the unlicensed spectrum, such as using e.g., no LBT, deterministic LBT, or a random backoff LBT,
Load Based Equipment, LBE, channel access parameters,
Frame Based Equipment, FBE, channel access parameters,
FBE COT length, e.g., size of frame,
a switch between channel access mode of the COT, e.g., between LBE and
an indication of which node initiated the COT, e.g., when the COT is an FBE COT,
information about CP extension, and
an Energy Detection, ED, threshold.

Embodiment 13. A computer program comprising instructions, which when executed by a processor, causes the processor to perform actions according to any of the Embodiments 7-12.

Embodiment 14. A carrier comprising the computer program of Embodiment 13, wherein the carrier is one of an electronic signal, an optical signal, an electromagnetic signal, a magnetic signal, an electric signal, a radio signal, a microwave signal, or a computer-readable storage medium.

Embodiment 15. A network node 110 e.g., configured to handle a Side Link, SL, communication over an unlicensed spectrum, between one or more peers comprising at least a first User Equipment, UE, 121 and a second UE 122 in a wireless communications network 100, the network node 110 e.g., being configured to any one or more out of:
initiate, e.g., by means of an initiating unit comprised in the network node 110, a Channel Occupancy Time, COT, to be used for the SL communication, e.g., wherein the COT is adapted to be a time period for performing SL communication using the unlicensed spectrum, and
signal e.g., by means of a signalling unit comprised in the network node 110, an indication of COT parameters to at least one of the one or more peers, e.g., any one or more out of the first UE 121 and the second UE 122, enabling at least one of the one or more of the peers, e.g., the first UE 121 and/or the second UE 122, to start the SL communication during the COT e.g., based on access information indicated by the indication of COT parameters.

Embodiment 16. The network node 110 according to Embodiment 15, wherein the network node 110 further is configured e.g., to any one or more out of:
obtain e.g., by means of an obtaining unit comprised in the network node 110, an indication that the first UE 121 requires to transmit data to the second UE 122 over an SL communication, e.g., by receiving a request from any one or more out of the first UE 121 and the second UE 122, e.g., requesting the network node 110 to initiate the COT, and
initiate e.g., by means of the initiating unit comprised in the network node 110, the COT for the unlicensed spectrum is based on, and/or triggered by, the obtained indication or received request.

Embodiment 17. The network node 110 according to any of Embodiments 15-16, wherein the indication of COT parameters is adapted to comprise an indication of a channel assessment procedure to use before communicating using the unlicensed spectrum during the COT, e.g., wherein the channel assessment is adapted to comprise any one out of:
e.g., Category 1, no LBT, e.g., with immediate transmission after a short switching gap time,
e.g., Category 2, use LBT without a random back-off, e.g., wherein a duration of time that the channel is sensed to be idle before the transmitting UE transmits is deterministic,
e.g., Category 3, LBT with random back-off using a contention window of fixed size,
e.g., Category 4, LBT with random back-off using a contention window of a variable size,
e.g., Category X, e.g., with a defined sensing time before transmission and with a defined switching gap time, e.g., different from Category 1.

Embodiment 18. The network node 110 according to any of Embodiments 15-17, wherein the indication of the COT parameters is adapted to comprise an indication of any one or more out of:
an LBT category indicating how to perform for channel assessment, e.g., for detecting presence of other UE's transmissions in the unlicensed spectrum, such as using e.g., no LBT, deterministic LBT, or a random backoff LBT,
Load Based Equipment, LBE, channel access parameters,
Frame Based Equipment, FBE, channel access parameters,
FBE COT length, e.g., size of frame,
a switch between channel access mode of the COT, e.g., between LBE and FBE, e.g., and associated switching time,
an indication of which node initiated the COT, e.g., when the COT is an FBE COT,
information about CP extension, and
an Energy Detection, ED, threshold.

Embodiment 19. A first User Equipment, UE, 121 or a second UE 122 e.g., configured to handle a Side Link, SL, communication over an unlicensed spectrum, between one or more peers comprising at least the first UE 121 and the second UE 122 in a wireless communications network 100, the first UE 121 or the second UE 122 being e.g., configured to any one or more out of:
receive, e.g., by means of a receiving unit comprised in the first UE 121 or the second UE 122, e.g., from the network node 110, an indication of Channel Occupancy Time, COT, parameters, e.g., enabling the first UE 121 and/or the second UE 122 to start the SL communication during the COT, e.g., wherein the COT is adapted to be a time period for performing SL communication using the unlicensed spectrum, start e.g., by means of a starting unit comprised in the first UE 121 or the second UE 122, the SL communication during the COT e.g., based on access information indicated by the indication of COT parameters.

Embodiment 20. The first UE 121 or the second UE 122 according to Embodiment 19, further configured to:
e.g., by means of a determining unit comprised in the first UE 121 or the second UE 122, based on the COT parameters, determine how to perform SL communication using the unlicensed spectrum during the COT, e.g., for transmitting and/or receiving SL data e.g., between the one or more peers.

Embodiment 21. The first UE 121 or the second UE 122 according to any of Embodiments 19-20, further configured to:
request, e.g., by means of a requesting unit comprised in the first UE 121 or the second UE 122, e.g., the network node 110, e.g., to transmit data to the first UE 121 or the second UE 122, over an SL communication, and/or to initiate the COT for the unlicensed spectrum, e.g., for SL communication over the unlicensed spectrum between the one or more peers.

Embodiment 22. The first UE 121 or the second UE 122 according to any of Embodiments 19-21, further configured to determine e.g., by means of the determining unit comprised in the first UE 121 or the second UE 122, how to perform SL communication using the unlicensed spectrum during the COT, by determining a channel assessment procedure to use before communicating using the unlicensed spectrum during the COT, e.g., if, and/or how to perform Listen Before Talk, LBT, e.g., which LBT category to use.

Embodiment 23. The first UE 121 or the second UE 122 according to any of Embodiments 19-22, wherein the indication of COT parameters is adapted to comprise an indication of a channel assessment procedure to use before communicating using the unlicensed spectrum during the COT, e.g., wherein the channel assessment is adapted to comprise any one out of:
e.g., Category 1, no LBT, e.g., with immediate transmission after a short switching gap time,
e.g., Category 2, use LBT without a random back-off, e.g., wherein a duration of time that the channel is sensed to be idle before the transmitting entity transmits is deterministic,
e.g., Category 3, LBT with random back-off using a contention window of fixed size,
e.g., Category 4, LBT with random back-off using a contention window of a variable size,
e.g., Category X, e.g., with a defined sensing time before transmission and with a defined switching gap time, e.g., different from Category 1,

Embodiment 24. The first UE 121 or the second UE 122 according to any of Embodiments 19-23, wherein the indication of the COT parameters is adapted to comprise an indication of any one or more out of:
an LBT category indicating how to perform for channel assessment, e.g., for detecting presence of other UE's transmissions in the unlicensed spectrum, such as using e.g., no LBT, deterministic LBT, or a random backoff LBT,
Load Based Equipment, LBE, channel access parameters,
Frame Based Equipment, FBE, channel access parameters,
FBE COT length, e.g., size of frame,
a switch between channel access mode of the COT, e.g., between LBE and FBE, e.g., and associated switching time,
an indication of which node initiated the COT, e.g., when the COT is an FBE COT,
information about CP extension, and
an Energy Detection, ED, threshold.

### Abbreviation Explanation

CA Carrier Aggregation
CBR Channel Busy Ratio
COT Channel Occupancy Time
CQI Channel Quality Indicator
CSI Channel State Information
DFN Direct Frame Number
DL Downlink
DRX Discontinuous Reception
FDD Frequency Division Duplex
GNSS Global Navigation Satellite System
HARQ Hybrid automatic repeat request
IE Information Element
MAC Medium Access Control
MIB Master Information Block
NSPS National Security and Public Safety
OoC Out-of-Coverage
PDCCH Physical Downlink Control Channel
PDCP Packet Data Convergence Protocol
PDU Protocol Data Unit
PHY Physical (layer)
PL Path Loss
PMI Precoding Matrix Indicator
ProSe Proximity Services
PSCCH Physical Sidelink Control Channel
PSSCH Physical Sidelink Shared Channel
RL Relay
RLC Radio link control
RM Remote
RI Rank Indicator
RRC Radio Resource Control
RSRP Reference Signal Received Power
RSSI Received Signal Strength Indicator
RX Receive, receiver
SFN System Frame Number
SIB System Information Block
SINR Signal to interference noise ration
SL Sidelink
SLRB Sidelink Radio Bearer
SLSS Sidelink Synchronization Signals
SMF Session Management Function
SynchUE Synchronization UE
TDD Time Division Duplex
TETRA Terrestrial Trunked Radio
TA Time advance
TX Transmit, transmitter
UE User Equipment
UL Uplink
UPF User Plane Function
V2V Vehicle-to-vehicle
V2X Vehicle-to-anything

### Further Extensions and Variations

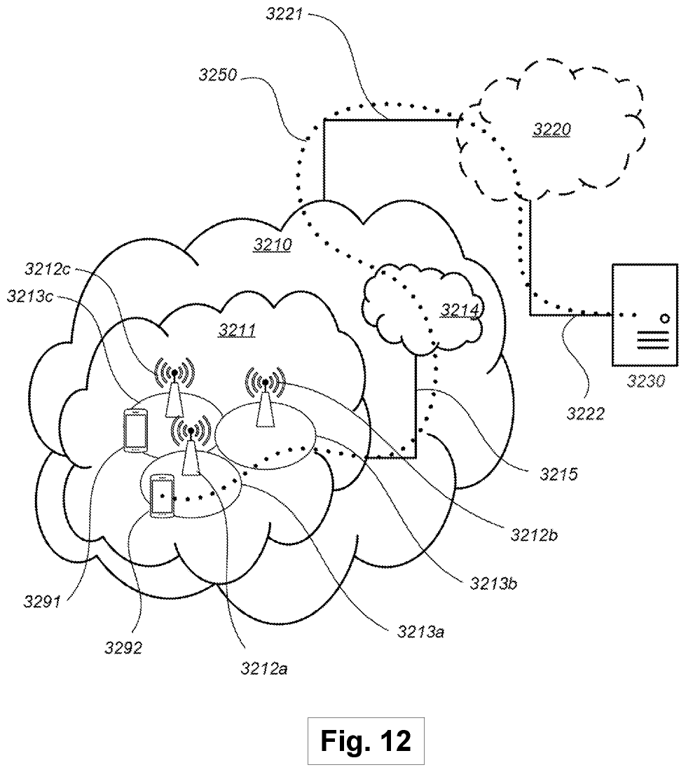

With reference to FIG. 12, in accordance with an embodiment, a communication system includes a telecommunication network 3210 such as the wireless communication network 100, e.g., an IoT network, or a WLAN, such as a 3GPP-type cellular network, which comprises an access network 3211, such as a radio access network, and a core network 3214. The access network 3211 comprises a plurality of base stations 3212a, 3212b, 3212c, such as the network node 110, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first UE e.g., the first UE 121, such as a Non-AP STA 3291 located in coverage area 3213c is configured to wirelessly connect to, or be paged by, the corresponding base station 3212c. A second UE 3292 e.g., the first UE 121, such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 12 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signalling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

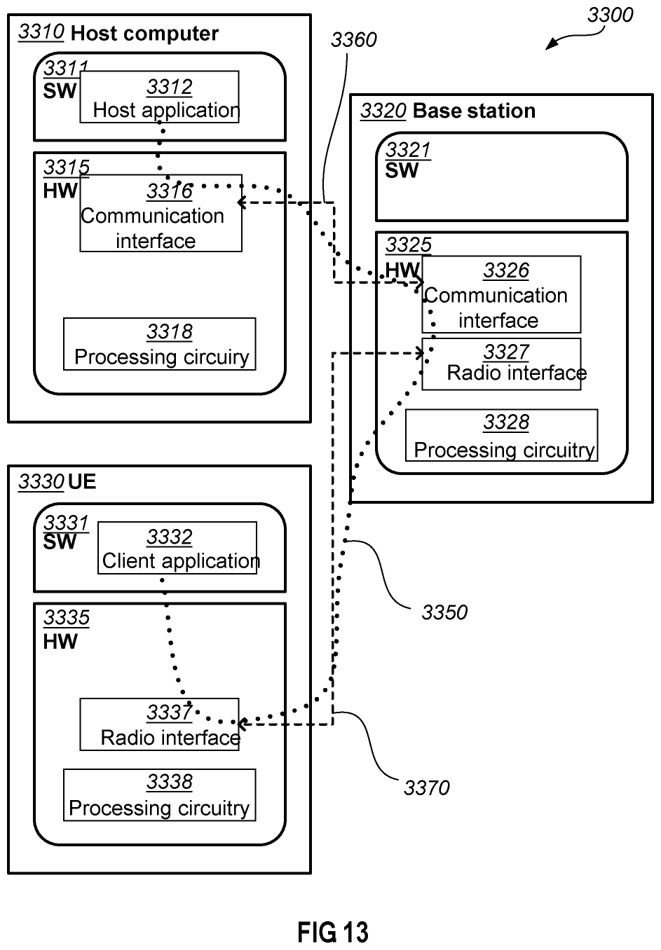

Example implementations, in accordance with an embodiment, of the UE, base station and host computer discussed in the preceding paragraphs will now be described with reference to FIG. 13. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown in FIG. 13) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 13 may be identical to the host computer 3230, one of the base stations 3212a, 3212b, 3212c and one of the UEs 3291, 3292 of FIG. 12, respectively. This is to say, the inner workings of these entities may be as shown in FIG. 13 and independently, the surrounding network topology may be that of FIG. 12.

In FIG. 13, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the applicable RAN effect: data rate, latency, power consumption, and thereby provide benefits such as corresponding effect on the OTT service: e.g., reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signalling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

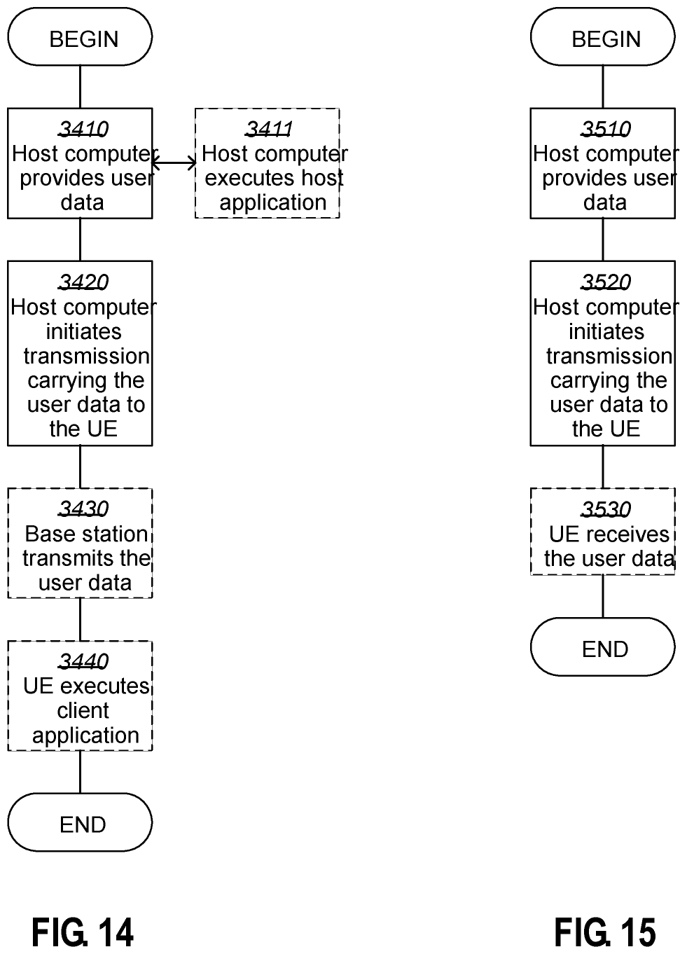

FIG. 14 is a flowchart illustrating a method implemented in a communication system, in accordance with one embodiment. The communication system includes a host computer, a base station such as the network node 110, and a UE such as the first UE 121, which may be those described with reference to FIG. 13 and FIG. 12. For simplicity of the present disclosure, only drawing references to FIG. 14 will be included in this section. In a first action 3410 of the method, the host computer provides user data. In an optional sub action 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 15 is a flowchart illustrating a method implemented in a communication system, in accordance with one embodiment. The communication system includes a host computer, a base station such as an AP STA, and a UE such as a Non-AP STA which may be those described with reference to FIG. 12 and FIG. 13. For simplicity of the present disclosure, only drawing references to FIG. 15 will be included in this section. In a first action 3510 of the method, the host computer provides user data. In an optional sub action (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

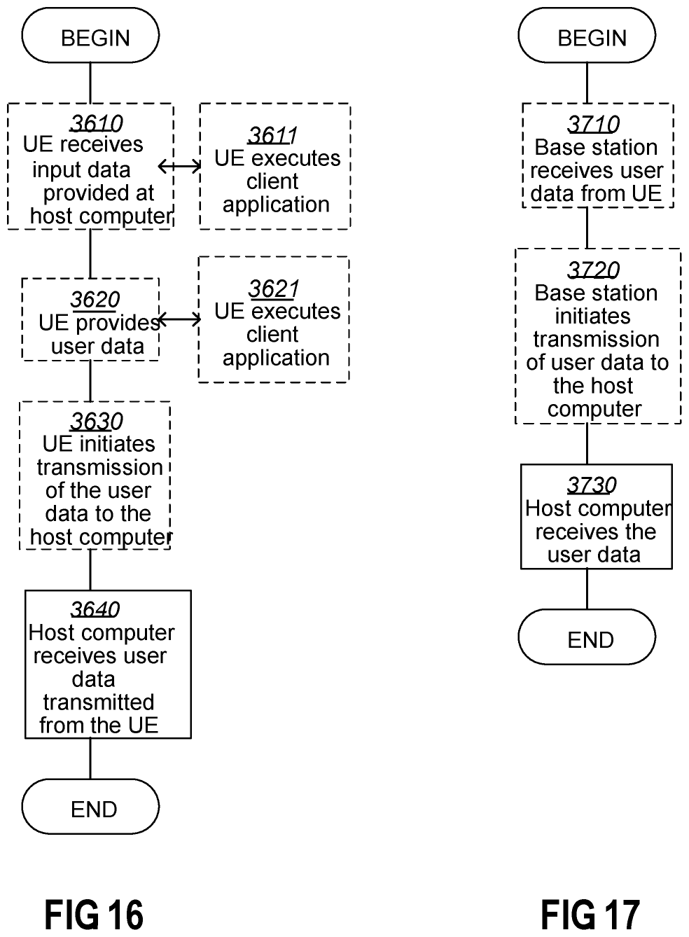

FIG. 16 is a flowchart illustrating a method implemented in a communication system, in accordance with one embodiment. The communication system includes a host computer, a base station such as an AP STA, and a UE such as a Non-AP STA which may be those described with reference to FIG. 12 and FIG. 13. For simplicity of the present disclosure, only drawing references to FIG. 16 will be included in this section. In an optional first action 3610 of the method, the UE receives input data provided by the host computer. Additionally or alternatively, in an optional second action 3620, the UE provides user data. In an optional sub action 3621 of the second action 3620, the UE provides the user data by executing a client application. In a further optional sub action 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third sub action 3630, transmission of the user data to the host computer. In a fourth action 3640 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station such as an AP STA, and a UE such as a Non-AP STA which may be those described with reference to FIG. 12 and FIG. 13. For simplicity of the present disclosure, only drawing references to FIG. 16 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

1-28. (canceled)

29. A method performed by a network node for handling a Side Link (SL) communication over an unlicensed spectrum, between one or more peers comprising at least a first User Equipment (UE) and a second UE in a wireless communications network, the method comprising:
initiating a Channel Occupancy Time (COT) to be used for the SL communication, wherein the COT is a time period for performing SL communication using the unlicensed spectrum, and
signalling an indication of COT parameters to at least one of the one or more peers, enabling at least one of the one or more of the peers, to start the SL communication during the COT.

30. The method of claim 29, wherein the method further comprises:
obtaining an indication that the first UE requires to transmit data to the second UE over an SL communication, and wherein
initiating the COT for the unlicensed spectrum is based on and/or triggered by the obtained indication.

31. The method of claim 29, wherein the indication of COT parameters comprises an indication of a channel assessment procedure to use before communicating using the unlicensed spectrum during the COT.

32. The method of claim 31, wherein the channel assessment comprises any one out of:
no Listen Before Talk (LBT),
use LBT without a random back-off,
LBT with random back-off using a contention window of fixed size,
LBT with random back-off using a contention window of a variable size, and
a defined sensing time before transmission and with a defined switching gap time.

33. The method of claim 29, wherein the indication of the COT parameters comprises an indication of any one or more out of:
an LBT category indicating how to perform for channel assessment,
Load Based Equipment (LBE) channel access parameters,
Frame Based Equipment (FBE) channel access parameters,
a FBE COT length,
a switch between channel access mode of the COT,
an indication of which node initiated the COT,
information about CP extension, and
an Energy Detection (ED) threshold.

34. A method performed by a first User Equipment (UE) or second UE for handling a Side Link (SL) communication over an unlicensed spectrum, between one or more peers comprising at least the first UE and the second UE in a wireless communications network, the method comprising:
receiving an indication of Channel Occupancy Time (COT) parameters, wherein the COT is a time period for performing SL communication using the unlicensed spectrum, and
starting the SL communication during the COT based on access information indicated by the indication of COT parameters.

35. The method of claim 34, further comprising:
based on the COT parameters, determining how to perform SL communication using the unlicensed spectrum during the COT.

36. The method of claim 35, wherein determining how to perform SL communication using the unlicensed spectrum during the COT, comprises determining a channel assessment procedure to use before communicating using the unlicensed spectrum during the COT.

37. The method of claim 34, further comprising:
requesting to initiate the COT for the unlicensed spectrum for SL communication over the unlicensed spectrum between the one or more peers.

38. The method of claim 34, wherein the indication of COT parameters comprises an indication of a channel assessment procedure to use before communicating using the unlicensed spectrum during the COT.

39. The method of claim 38 wherein the channel assessment comprises any one out of:
no Listen Before Talk (LBT),
use LBT without a random back-off,
LBT with random back-off using a contention window of fixed size,
LBT with random back-off using a contention window of a variable size, and
a defined sensing time before transmission and with a defined switching gap time.

40. The method of claim 34, wherein the indication of the COT parameters comprises an indication of any one or more out of:
an LBT category indicating how to perform for channel assessment,
Load Based Equipment (LBE) channel access parameters,
Frame Based Equipment (FBE) channel access parameters,
a FBE COT length,
a switch between channel access mode of the COT,
an indication of which node initiated the COT,
information about CP extension, and
an Energy Detection (ED) threshold.

41. A network node configured to handle a Side Link (SL) communication over an unlicensed spectrum, between one or more peers comprising at least a first User Equipment (UE) and a second UE, in a wireless communications network, the network node comprising communication interface circuitry and processing circuitry operatively coupled to the communication interface circuitry and configured to:
initiate a Channel Occupancy Time (COT) to be used for the SL communication, wherein the COT is adapted to be a time period for performing SL communication using the unlicensed spectrum, and
signal an indication of COT parameters to at least one of the one or more peers, enabling at least one of the one or more of the peers to start the SL communication during the COT.

42. The network node of claim 41, wherein the processing circuitry is further configured to:
obtain an indication that the first UE requires to transmit data to the second UE over an SL communication, and
initiate the COT for the unlicensed spectrum based on and/or triggered by the obtained indication.

43. The network node of claim 41, wherein the indication of COT parameters comprises an indication of a channel assessment procedure to use before communicating using the unlicensed spectrum during the COT.

44. A user equipment (UE) configured to handle a Side Link (SL) communication over an unlicensed spectrum, between one or more peers comprising at least the UE and s second UE in a wireless communications network, the UE comprising communication interface circuitry and processing circuitry operatively coupled to the communication interface circuitry and configured to:
receive an indication of Channel Occupancy Time (COT) parameters, wherein the COT is adapted to be a time period for performing SL communication using the unlicensed spectrum,
start the SL communication during the COT based on access information indicated by the indication of COT parameters.

45. The UE of claim 44, wherein the processing circuitry is further configured to:
based on the COT parameters, determine how to perform SL communication using the unlicensed spectrum during the COT.

46. The UE of claim 45, wherein the processing circuitry is configured to determine how to perform SL communication using the unlicensed spectrum during the COT by determining a channel assessment procedure to use before communicating using the unlicensed spectrum during the COT.

47. The UE of claim 44, wherein the processing circuitry is further configured to:
request to initiate the COT for the unlicensed spectrum for SL communication over the unlicensed spectrum between the one or more peers.
